(19) United States
(12) Patent Application Publication
(10) Pub. No.: US 2026/0245478 A1
(43) Pub. Date: Aug. 20, 2026

(54) INFORMATION PROCESSING APPARATUS, METHOD, AND STORAGE MEDIUM

(71) Applicant: WASEDA UNIVERSITY, Tokyo (JP)

(72) Inventors: Hiroaki TAKATSU, Shinjuku Tokyo (JP); Yoichi MATSUYAMA, Shinjuku Tokyo (JP); Shungo SUZUKI, Shinjuku Tokyo (JP); Mao SAEKI, Shinjuku Tokyo (JP); Ryuki MATSUURA, Shinjuku Tokyo (JP)

(21) Appl. No.: 19/647,677

(22) Filed: Apr. 14, 2026

Related U.S. Application Data
(63) Continuation of application No. PCT/JP2024/034466, filed on Sep. 26, 2024.

(30) Foreign Application Priority Data
Oct. 14, 2023 (JP) 2023-177926

(51) Int. Cl. G09B 19/06; G06F 40/253; G06F 40/289; G06F 40/40; G10L 15/02; G10L 15/04; G10L 25/51

(52) U.S. Cl. CPC G09B 19/06; G06F 40/253; G06F 40/289; G06F 40/40; G10L 15/02; G10L 15/04; G10L 25/51

(57) ABSTRACT

An information processing apparatus for assessing proficiency of a language, includes a memory that stores a program; and a processor configured to execute the program to: acquire multimodal input data of the language, the multimodal input data including a combination of two or more of text information, audio information, and video information; extract, from the acquired multimodal input data, a plurality of linguistic features including a multimodal feature in which features of different modalities of the multimodal input data are blended with one another; calculate a score for each of a plurality of indices of the proficiency based on the extracted plurality of linguistic features; calculate, as a basis for the score, a contribution degree of each of the plurality of linguistic features to the calculated score; and output the score for each of the plurality of indices together with the basis for the score.

### CROSS-REFERENCE TO RELATED APPLICATION

This application is a continuation of International Patent Application No. PCT/JP2024/034466 filed Sep. 26, 2024, which is based upon and claims the benefit of priority from Japanese Patent Application No. 2023-177926, filed Oct. 14, 2023, the entire contents of which are incorporated herein by reference.

### TECHNICAL FIELD

The present disclosure relates to an information processing apparatus, a method, and a storage medium.

### BACKGROUND ART

There is a known technique for predicting speaking proficiency in a language by machine learning based on phoneme information obtained by performing speech recognition on a user's utterance voice.

### SUMMARY

In advancing second language learning, proficiency evaluation for understanding the current state of a learner (user) is indispensable. In second language learning, there are innumerable items that must be acquired, such as grammar, vocabulary, and pronunciation; however, as in the above-described prior art, it is common practice to extract features (such as pitch, speech rate, and pause duration) that are specialized for measuring a specific language proficiency (e.g., fluency) from the user's utterance voice, and to predict proficiency based on those features. However, in order to measure language proficiency from various perspectives (such as coherence and interactional quality), it is necessary to consider various linguistic features contained in multimodal information (utterance data) obtained during the user's utterance; therefore, it is difficult to accurately and diagnostically assess individual language proficiencies using only the limited features extracted from the utterance voice as in the above-described prior art. Note that utterance data is also referred to as input data.

Embodiments of the present disclosure provide an information processing apparatus, a method, and a storage medium to diagnostically assess language proficiency from a plurality of perspectives based on diverse linguistic features contained in a user's multimodal utterance data.

According to one embodiment, there is provided an information processing apparatus for assessing proficiency of a language, comprising: a memory that stores a program; and a processor configured to execute the program to: acquire multimodal input data of the language, the multimodal input data including a combination of two or more of text information, audio information, and video information; extract, from the acquired multimodal input data, a plurality of linguistic features including a multimodal feature in which features of different modalities of the multimodal input data are blended with one another; calculate a score for each of a plurality of indices of the proficiency based on the extracted plurality of linguistic features; calculate, as a basis for the score, a contribution degree of each of the plurality of linguistic features to the calculated score; and output the score for each of the plurality of indices together with the basis for the score.

According to one embodiment, language proficiency can be diagnostically assessed based on diverse linguistic features contained in a user's multimodal input data.

### BRIEF DESCRIPTION OF DRAWINGS

FIG. 1 is a diagram showing an example of a configuration of an information processing system.

FIG. 2 is a diagram showing an example of a hardware configuration of a language proficiency diagnostic assessment apparatus.

FIG. 3 is a diagram showing an example of a hardware configuration of a user terminal.

FIG. 4 is a diagram showing an example of a functional configuration of the language proficiency diagnostic assessment apparatus.

FIG. 5 is a diagram showing an example of a concept of the language proficiency diagnostic assessment apparatus.

FIG. 6 is a diagram showing an example of a multimodal feature extractor.

FIG. 7 is a diagram showing an example of a vocabulary difficulty feature extractor.

FIG. 8 is a diagram showing an example of a pronunciation feature extractor.

FIG. 9 is a diagram showing an example of a discourse feature extractor.

FIG. 10 is a diagram showing an example of a relationship between discourse markers and classes.

FIG. 11 is a diagram showing an example of a sentence in which part of a discourse marker has been masked.

FIG. 12 is a diagram showing an example of a coreference feature extractor.

FIG. 13 is a diagram showing an example of a coreference relation.

FIG. 14 is a diagram showing an example of scores for each index obtained by the score measurement unit.

FIG. 15 is a diagram showing an example of a concept of normalization.

FIG. 16 is a diagram showing an example of a processing flow of the complex feature model.

FIG. 17 is a diagram showing an example of a processing flow of the multimodal feature encoder.

FIG. 18 is a diagram showing an example of a general processing flow of encoders other than the multimodal feature encoder.

FIG. 19 is a diagram showing an example of a processing flow of an ensemble model that outputs overall proficiency in the complex feature model.

FIG. 20 is a diagram showing an example of a processing flow of the simple feature model.

FIG. 21 is a diagram showing an example of visualization using a radar chart.

FIG. 22 is a diagram showing an example of visualization of a basis.

FIG. 23 is a diagram showing an example of visualization of a basis.

FIG. 24 is a diagram showing an example of visualization of CEFR levels of vocabulary contained in a user utterance.

FIG. 25 is a diagram showing an example of visualization of grammatical error features.

FIG. 26 is a diagram showing an example of visualization of discourse features.

FIG. 27 is a diagram showing an example of visualization of pronunciation quality.

### DETAILED DESCRIPTION

Each embodiment of the present disclosure will be described below with reference to the accompanying drawings. Note that, with respect to descriptions in the specification and drawings according to each embodiment, components having substantially the same functional configuration are denoted by the same reference numerals, and redundant descriptions are omitted.

### <System Configuration>

First, an overview of the information processing system 1000 according to the present embodiment will be described. The information processing system 1000 diagnostically assesses the functional language proficiency of a user who is acquiring a second language, a third language, or the like, that is, a language learner, by using techniques such as machine learning. Note that, in the present disclosure, functional language proficiency refers to the ability to sufficiently and appropriately achieve a non-linguistic outcome given by a situation (the ability to sufficiently and appropriately achieve specific tasks of daily life through the language one wishes to acquire). Here, functional language proficiency is also simply referred to as language proficiency. For functional language proficiency, refer to (Reference 1) F. Kuiken and I. Vedder, “TASK. Journal on Task-Based Language Teaching and Learning”, Volume 2, Number 1, John Benjamins, Amsterdam (the Netherlands), 2022, and (Reference 2) N. Taguchi and Y. Kim, Eds., “Task-Based Approaches to Teaching and Assessing Pragmatics”, Chap. 11, Longmans Green and Co. (USA), 2018, Chap. 11, pp. 266-285.

The information processing system 1000 is used to help language learners efficiently acquire a second language. The information processing system 1000 can also support the language performance of language learners. Language performance refers to actually observable utterances focused on the characteristics of the utterance itself (e.g., fluency). For language performance, refer to Reference 1 and Reference 2 above.

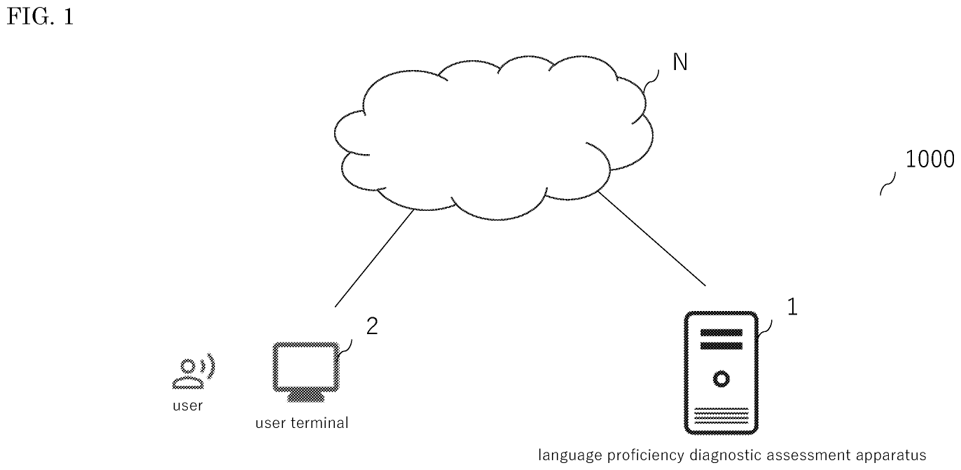

FIG. 1 is a diagram showing an example of a configuration of the information processing system 1000. As shown in FIG. 1, the information processing system 1000 comprises a language proficiency diagnostic assessment apparatus 1 and a user terminal 2 that are communicably connected to each other via a network N. The network N is, for example, a wired LAN (Local Area Network), a wireless LAN, the Internet, a public switched telephone network, a mobile data communication network, or a combination thereof. In the example of FIG. 1, the information processing system 1000 comprises one language proficiency diagnostic assessment apparatus 1 and one user terminal 2 each, but may comprise a plurality of each.

The language proficiency diagnostic assessment apparatus 1 is an information processing apparatus that diagnostically assesses the language proficiency of a user based on input data from the user. The language proficiency diagnostic assessment apparatus 1 is, for example, a PC (Personal Computer), a smartphone, a tablet terminal, a server apparatus, a microcomputer, or a robot, but is not limited thereto. In the example of FIG. 1, the language proficiency diagnostic assessment apparatus 1 is a single information processing apparatus, but may be realized as a system comprising a plurality of information processing apparatuses connected via the network N. In addition, the language proficiency diagnostic assessment apparatus 1 may diagnostically assess the language proficiency of the user, taking the utterances by the user during the conversation (user utterances) as input, after the user has completed an entire series of conversations (tasks). The language proficiency diagnostic assessment apparatus 1 may also analyze the utterances by the user in real time during the user's conversation.

The user terminal 2 is an information processing apparatus used by the in user that transmits input data to the language proficiency diagnostic assessment apparatus 1 and displays the evaluation result of language proficiency. The user terminal 2 is, for example, a PC, a smartphone, a tablet terminal, a server apparatus, AR (Augmented Reality) goggles, VR (Virtual Reality) goggles, or a microcomputer, but is not limited thereto. The user terminal 2 may acquire input data from an external apparatus and transmit the acquired input data to the language proficiency diagnostic assessment apparatus 1. In addition, the user terminal 2 may comprise a camera and a microphone and transmit input data captured by the camera or input data collected by the microphone to the language proficiency diagnostic assessment apparatus 1. In this case, the user may himself/herself capture or collect his/her own input data, or may have a person other than the user capture or collect his/her input data. Furthermore, the user terminal 2 that transmits input data and the user terminal 2 that displays the evaluation result may be different information processing apparatuses.

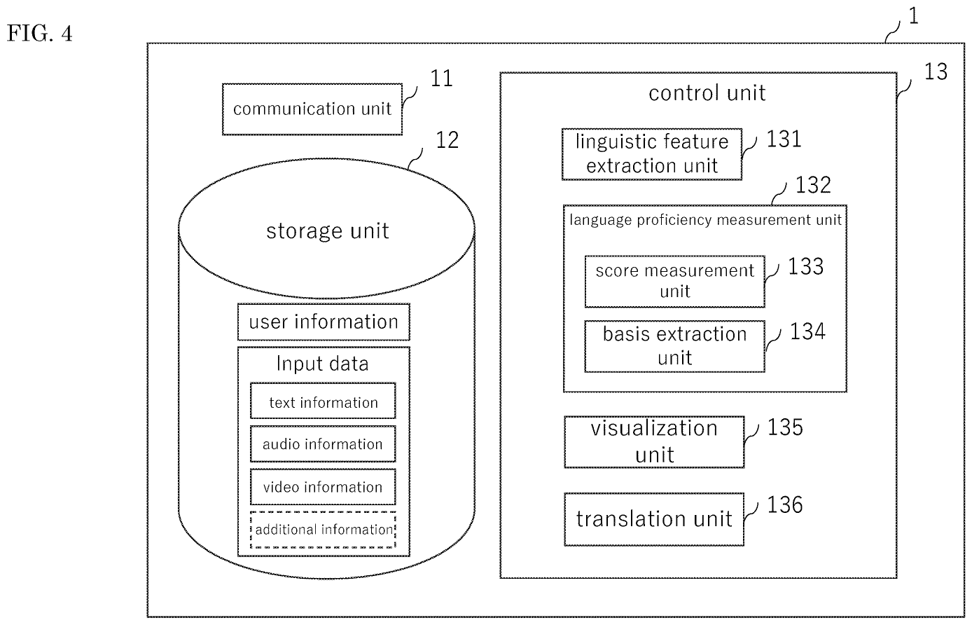

Input data refers to information emitted by the user and is any one or combination of text information, audio information, and video information. Input data will be described later with reference to FIG. 4.

### <Hardware Configuration of Language Proficiency Diagnostic Assessment Apparatus 1>

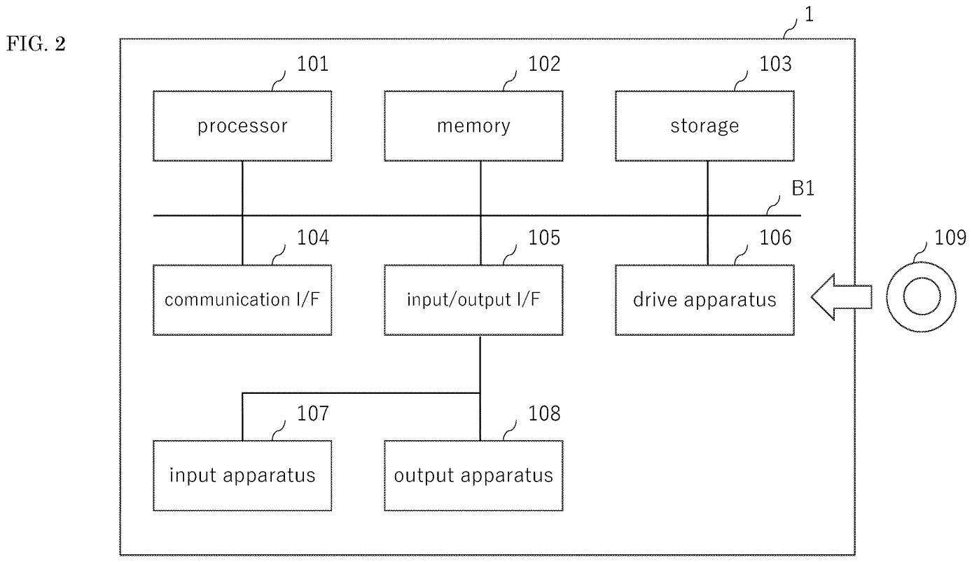

Next, the hardware configuration of the language proficiency diagnostic assessment apparatus 1 will be described. FIG. 2 is a diagram showing an example of the hardware configuration of the language proficiency diagnostic assessment apparatus 1. As shown in FIG. 2, the language proficiency diagnostic assessment apparatus 1 comprises a processor 101, a memory 102, a storage 103, a communication I/F 104, an input/output I/F 105, a drive apparatus 106, an input apparatus 107, and an output apparatus 108, which are mutually connected via a bus B1.

The processor 101 controls each component of the language proficiency diagnostic assessment apparatus 1 and realizes the functions of the language proficiency diagnostic assessment apparatus 1 by loading onto the memory 102 and executing various programs including an OS (Operating System) and a language proficiency diagnostic assessment program stored in the storage 103. The processor 101 is, for example, a CPU (Central Processing Unit), an MPU (Micro Processing Unit), a GPU (Graphics Processing Unit), an ASIC (Application Specific Integrated Circuit), or a DSP (Digital Signal Processor), but is not limited thereto.

The memory 102 is, for example, a ROM (Read Only Memory), a RAM (Random Access Memory), or a combination thereof. The ROM is, for example, a PROM (Programmable ROM), an EPROM (Erasable Programmable ROM), an EEPROM (Electrically Erasable Programmable ROM), or a combination thereof. The RAM is, for example, a DRAM (Dynamic RAM) or an SRAM (Static RAM), but is not limited thereto.

The storage 103 stores various programs and data including the OS and the language proficiency diagnostic assessment program. The storage 103 is, for example, a flash memory, an HDD (Hard Disk Drive), an SSD (Solid State Drive), or an SCM (Storage Class Memories), but is not limited thereto.

The communication I/F 104 is an interface for connecting the language proficiency diagnostic assessment apparatus 1 to an external apparatus via the network N and controlling communication. The communication I/F 104 is, for example, Bluetooth (registered trademark), Wi-Fi (registered trademark), ZigBee (registered trademark), or Ethernet (registered trademark), but is not limited thereto.

The input/output I/F 105 is an interface for connecting the input apparatus 107 and the output apparatus 108 to the language proficiency diagnostic assessment apparatus 1. The input apparatus 107 is an apparatus for inputting information to the language proficiency diagnostic assessment apparatus 1. The input apparatus 107 is, for example, a mouse, a keyboard, a touch panel, a microphone, a scanner, a camera, various sensors, operation buttons, or a combination thereof, but is not limited thereto. The output apparatus 108 is an apparatus for outputting information from the language proficiency diagnostic assessment apparatus 1. The output apparatus 108 is, for example, a display, a projector, a printer, a speaker, a vibrator, or a combination thereof, but is not limited thereto.

The drive apparatus 106 is an apparatus that reads and writes data on a recording medium 109. The drive apparatus 106 is, for example, a magnetic disk drive, an optical disk drive, a magneto-optical disk drive, or an SD card reader, but is not limited thereto. The recording medium 109 is, for example, a CD (Compact Disc), a DVD (Digital Versatile Disc), an FD (Floppy Disk), an MO (Magneto-Optical disk), a BD (Blu-ray (registered trademark) Disc), a USB (registered trademark) memory, or an SD card, but is not limited thereto.

Note that, in the present embodiment, the language proficiency diagnostic assessment program may be written into the memory 102 or the storage 103 at the manufacturing stage of the language proficiency diagnostic assessment apparatus 1, may be provided to the language proficiency diagnostic assessment apparatus 1 via the network N, or may be provided to the language proficiency diagnostic assessment apparatus 1 via a non-transitory computer-readable recording medium such as the recording medium 109.

### <Hardware Configuration of User Terminal 2>

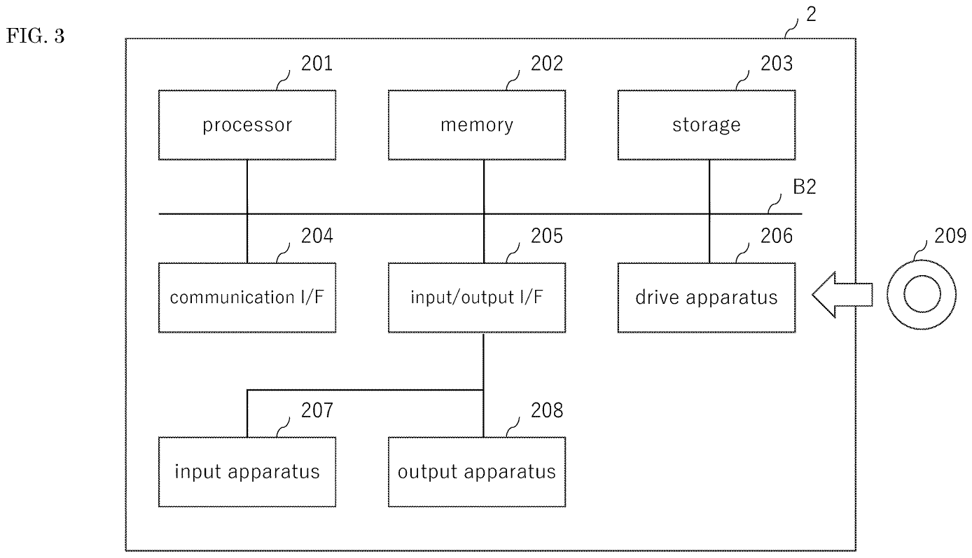

Next, the hardware configuration of the user terminal 2 will be described. FIG. 3 is a diagram showing an example of the hardware configuration of the user terminal 2. As shown in FIG. 3, the user terminal 2 comprises a processor 201, a memory 202, a storage 203, a communication I/F 204, an input/output I/F 205, a drive apparatus 206, an input apparatus 207, and an output apparatus 208, which are mutually connected via a bus B2.

The processor 201 controls each component of the user terminal 2 and realizes the functions of the user terminal 2 by loading onto the memory 202 and executing an OS and various programs stored in the storage 203. The processor 201 is, for example, a CPU, an MPU, a GPU, an ASIC, or a DSP, but is not limited thereto.

The memory 202 is, for example, a ROM, a RAM, or a combination thereof. The ROM is, for example, a PROM, an EPROM, an EEPROM, or a combination thereof. The RAM is, for example, a DRAM or an SRAM, but is not limited thereto.

The storage 203 stores an OS and various programs and data. The storage 203 is, for example, a flash memory, an HDD, an SSD, or an SCM, but is not limited thereto.

The communication I/F 204 is an interface for connecting the user terminal 2 to an external apparatus via the network N and controlling communication. The communication I/F 204 is, for example, Bluetooth (registered trademark), Wi-Fi (registered trademark), ZigBee (registered trademark), or Ethernet (registered trademark), but is not limited thereto.

The input/output I/F 205 is an interface for connecting the input apparatus 207 and the output apparatus 208 to the user terminal 2. The input apparatus 207 is an apparatus for inputting information to the user terminal 2. The input apparatus 207 is, for example, a mouse, a keyboard, a touch panel, a microphone, a scanner, a camera, various sensors, operation buttons, or a combination thereof, but is not limited thereto. The output apparatus 208 is an apparatus for outputting information from the user terminal 2. The output apparatus 208 is, for example, a display, a projector, a printer, a speaker, a vibrator, or a combination thereof, but is not limited thereto.

The drive apparatus 206 is an apparatus that reads and writes data on a recording medium 209. The drive apparatus 206 is, for example, a magnetic disk drive, an optical disk drive, a magneto-optical disk drive, or an SD card reader, but is not limited thereto. The recording medium 209 is, for example, a CD, a DVD, an FD, an MO, a BD (registered trademark), a USB (registered trademark) memory, or an SD card, but is not limited thereto.

The output apparatus 208 is an apparatus for outputting information from the user terminal 2. The output apparatus 208 is, for example, a mouse, a keyboard, a touch panel, a microphone, a scanner, an imaging apparatus (camera), various sensors, or operation buttons, but is not limited thereto.

### <Functional Configuration of Language Proficiency Diagnostic Assessment Apparatus 1>

Next, the functional configuration of the language proficiency diagnostic assessment apparatus 1 will be described. FIG. 4 is a diagram showing an example of the functional configuration of the language proficiency diagnostic assessment apparatus 1. As shown in FIG. 4, the language proficiency diagnostic assessment apparatus 1 comprises a communication unit 11, a storage unit 12, and a control unit 13.

The communication unit 11 is realized by the communication I/F 104. The communication unit 11 transmits and receives information to and from the user terminal 2 via the network N. The communication unit 11 receives input data from the user terminal 2. The communication unit 11 also transmits information such as diagnostic assessment results to the user terminal 2.

The storage unit 12 is realized by the memory 102 and the storage 103. The storage unit 12 stores user information and input data. Note that the storage unit 12 may be constructed by a database.

Input data is information emitted by the user and is any one or combination of text information, audio information, and video information. Text information may include a text string obtained by converting the user's utterance voice through a speech recognition system (not shown) or the like, or a text string input by the user using an input apparatus 207 such as a keyboard. Text information may also be text transcribed from audio emitted by a conversational agent to the user through an output apparatus 208 such as a speaker of the user terminal 2, or text displayed to the user by a conversational agent through an output apparatus 208 such as a display of the user terminal 2. Note that a conversational agent refers to a counterpart that converses with the user (learner) in place of a human teacher, and may be a system or a program. A conversational agent may also be, for example, a robot or a three-dimensional character, or may be realized solely by a disembodied voice.

Audio information includes audio emitted from the user's vocal cords. Audio information is also the audio of the user input to an input apparatus 207 such as a microphone of the user terminal 2, or audio emitted by a conversational agent to the user through an output apparatus 208 such as a speaker of the terminal.

Video information is video, input from an input apparatus 207 such as a camera of the user terminal 2, in which the user's facial expressions, mouth movements, gestures, and hand movements are recorded. Video information may also be video of actions shown to the user by a conversational agent through an output apparatus 208 such as a display of the user terminal 2.

Input data may be constituted by a combination of text information, audio information, and video information obtained by the above-described techniques. Input data may also be conversation data exchanged among a plurality of humans. Input data may be conversation data between a human and a conversational agent, or may be conversation data between a plurality of conversational agents. In that case, input data may include both text information, audio information, and video information generated by the interaction between the conversational agent and the user. Input data may also include output data generated by the conversational agent. Furthermore, the input data is not limited to conversation data and may be monologue utterance data. Input data may also be text information input with an input apparatus 207 such as a keyboard, that is, text information not accompanied by an utterance. Input data may also include additional information stored in the storage unit 12, and this additional information is information related to the user and may be, for example, the user's properties or learning objectives.

Note that each item of input data described above may be encrypted. In addition, text information, audio information, and video information may be arranged chronologically in the input data, but are not limited thereto.

The control unit 13 is realized by the processor 101 reading out and executing the language proficiency diagnostic assessment program from the memory 102 in cooperation with other hardware components. The control unit 13 controls the overall operation of the language proficiency diagnostic assessment apparatus 1. The control unit 13 comprises a linguistic feature extraction unit 131, a language proficiency measurement unit 132, a score measurement unit 133, a basis extraction unit 134, a visualization unit 135, and a translation unit 136.

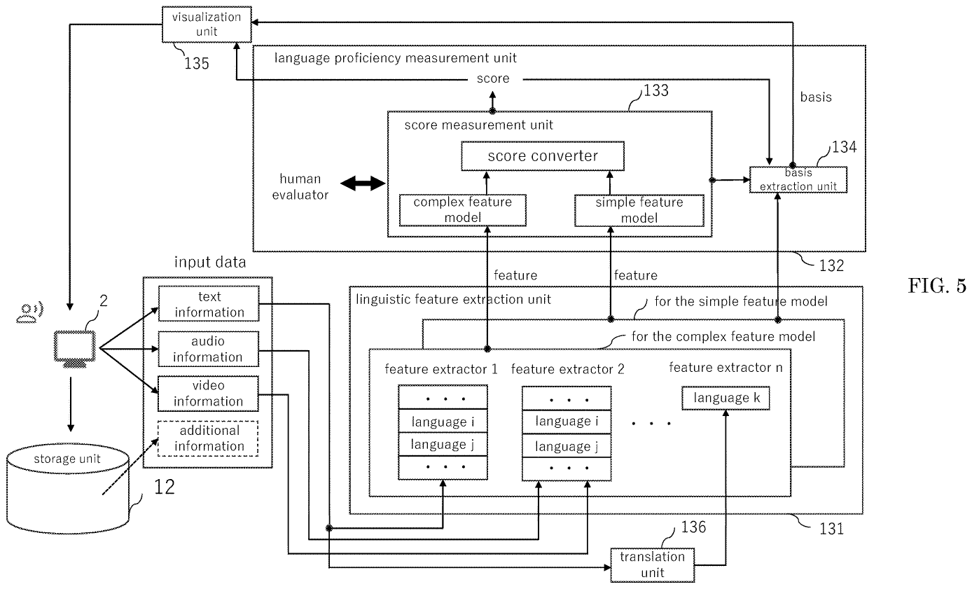

The linguistic feature extraction unit 131 will be described with reference to FIG. 5. FIG. 5 is an example of a conceptual diagram of the language proficiency diagnostic assessment apparatus 1. As illustrated in FIG. 5, the linguistic feature extraction unit 131 takes as input one or more items of information from among text information, audio information, and video information contained in the input data, and outputs specific linguistic features to the language proficiency measurement unit 132. The linguistic feature extraction unit 131 comprises one or more feature extractors. FIG. 5 illustrates the case where n feature extractors (n is an integer equal to or greater than 1) are provided, but the linguistic feature extraction unit 131 may comprise only one feature extractor. Note that the input data may be subjected to preprocessing such as noise removal or division into a plurality of data items. Note that linguistic features include text features, which are features obtained by converting text information into numerical information. That is, linguistic features are vectors obtained by converting text information, audio information, and video information contained in input data using statistical techniques, machine learning models, or the like.

The present system supports multiple languages and comprises feature extractors corresponding to a plurality of languages. FIG. 5 illustrates that feature extractors 1 through n each support a plurality of languages such as English and French. Language i, language j, and language k in FIG. 5 are, for example, French, German, and English, respectively. FIG. 5 illustrates that input data containing language i (French) and language j (German) is directly input to feature extractor 1 and feature extractor 2, while language k (English) via the translation unit 136 is input to feature extractor n. This assumes a case where, for example, the user's utterance is in French and the translation unit 136 has a function of translating from another language (e.g., French) into English, in which case only English (language k) is input to feature extractor n. Note that the definitions of languages and the feature extractors are not limited to those described above.

In addition, the linguistic feature extraction unit 131 comprises one or more feature extractors each for a complex feature model and for a simple feature model. The complex feature model and the simple feature model will be described later. Note that herein, a machine learning model is also simply referred to as a model.

In the present system, when using the index (perspective) of the well-known CEFR (Common European Framework of Reference for Languages: Learning, teaching, assessment), each feature extractor shall output all or any of text features, multimodal features, vocabulary difficulty features, grammatical error features, pronunciation features, discourse features, coreference features, commonsense features, and manually designed features as linguistic features. These feature extractors are referred to respectively as a text feature extractor, a multimodal feature extractor, a vocabulary difficulty feature extractor, a grammatical error feature extractor, a pronunciation feature extractor, a discourse feature extractor, a coreference feature extractor, a commonsense feature extractor, and a manually designed feature extractor. Feature extractors 1 through n illustrated in FIG. 5 each represent the above-mentioned extractors; for example, feature extractor 1 represents the text feature extractor and feature extractor 2 represents the multimodal feature extractor. Note that the feature extractors described above are merely examples, and other features may be extracted (output). Each of these feature extractors will be described below.

The feature extractor that extracts text features, i.e., the text feature extractor, will be described. The text feature extractor takes text information of the input data as input and outputs text features. The text feature extractor may obtain the output of the final layer or an intermediate layer of a pre-trained model (a trained model trained using a large dataset). In this case, the text feature extractor may use the well-known ALBERT (A Lite BERT) as an example of a pre-trained model and provide sentence-unit text information in conversation between the user and the conversational agent to ALBERT in chronological order. In this case, the text feature extractor also outputs from the feature extractor the output of the final layer of ALBERT (a vector sequence in token units). In language models such as ALBERT, text is processed in units called tokens. A token represents words, characters, subwords (units smaller than words but larger than characters), etc. that are constituent elements of a sentence, and the definition of tokens differs depending on the language model. Hereinafter, the unit of tokens is described as words.

In addition, as the pre-trained model, for example, the well-known Word2Vec (registered trademark) or BERT (Bidirectional Encoder Representations from Transformers, registered trademark) may be used, and the output of the final layer or an intermediate layer of these models may be obtained as text features. Word2Vec is a model that learns the meaning and grammatical characteristics of words through a task of predicting surrounding words from a certain word in a sentence, and when a word is input, outputs a vector in which the meaning and grammatical function of that word are embedded. BERT is a bidirectional encoding model with a structure of multiple stacked Transformer Encoders, and outputs embedding vectors that reflect the contextually considered meaning of words through a task of masking a certain word in a sentence and predicting the masked word from surrounding words, and a task of predicting whether two input sentences are consecutive sentences. ALBERT is a model that lightens BERT by improvements such as decomposing the word embedding representation matrix used in BERT into two smaller matrices.

Text features may be obtained as word occurrence frequencies when text information of the input data is analyzed using a technique such as the well-known TF-IDF (Term Frequency-Inverse Document Frequency). Note that TF-IDF is one of the statistical measures indicating how important each word in each sentence is within that sentence. By such a technique, text features, which are the features output by the text feature extractor, are features obtained by converting text information of the input data into numerical information. Note that a sentence is a unit consisting of one or more words and delimited by a period (“.”). A passage is a unit consisting of one or more sentences.

The output of the text feature extractor is numerical information such as a vector or a vector sequence. Text features may also be multidimensional vectors in units of sentences or words. When the input to the text feature extractor is text information consisting of a plurality of sentences or words, text features may be obtained as a multidimensional vector sequence; when the entire text information is taken as input, text features may be obtained as a single vector.

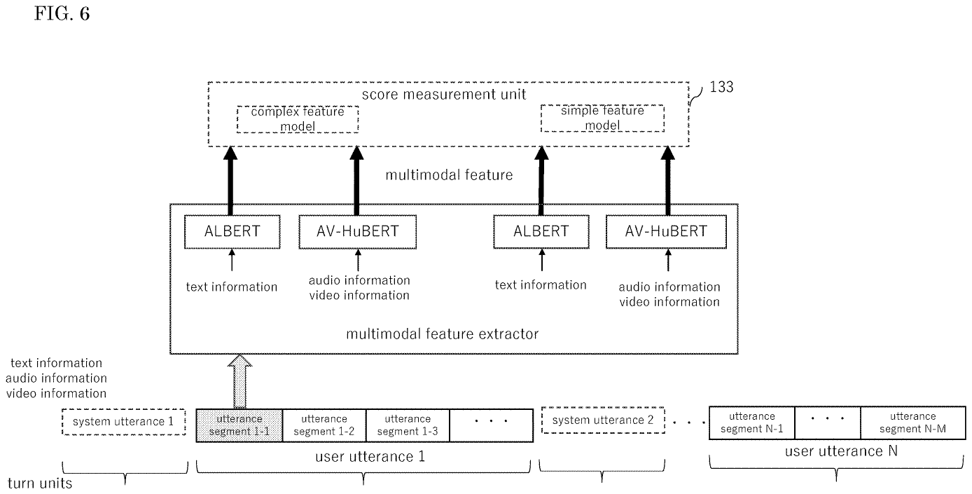

The feature extractor that extracts multimodal features, i.e., the multimodal feature extractor, will be described with reference to FIG. 6. FIG. 6 is a diagram showing an example of the multimodal feature extractor. As illustrated in FIG. 6, the multimodal feature extractor takes as input a combination of two or more items from among text information, audio information, and video information contained in the input data, and outputs multimodal features.

The form of input data to the multimodal feature extractor and the multimodal feature extraction process will be described. When the input data is a conversation between a conversational agent and a user, the input data, i.e., text information, audio information, and video information, may take a form in which system utterances, which are utterances by the conversational agent, and user utterances appear alternately. FIG. 6 illustrates this form; specifically, it indicates that system utterance 1, user utterance 1, system utterance 2, . . . , user utterance N (N is an integer equal to or greater than 1) occur sequentially in the conversation.

As illustrated in FIG. 6, a user utterance consists of one or more utterance segments. An utterance segment is a unit delimited at positions of punctuation marks (e.g., “,”, “?”, “·”, “!”) in text information and at positions where pauses in audio information are of a certain length or more (e.g., 0.5 seconds or more). Note that when dividing a user utterance, the unit is not limited to utterance segments. The multimodal feature extractor receives input in units of utterance segments and in the order they were uttered. That is, utterance segment 1-1 is first input to the multimodal feature extractor, then utterance segment 1-2 is input, and finally utterance segment N-M is input.

When utterance segment data is input to the multimodal feature extractor in the form of input data as described above, the multimodal feature extractor outputs multimodal features in which text information, audio information, and video information contained in the utterance segment data are blended (with interaction taken between features across modalities). In generating multimodal features, first, the well-known pre-trained model ALBERT is used to extract text features from text information contained in the utterance segment data. These text features are a vector sequence in which word-unit information constituting the text information of the utterance segment is embedded.

Also, the well-known pre-trained model AV-HuBERT (Audio-Visual Hidden Unit BERT) is used to extract audio-visual features from a combination of audio information and video information contained in the utterance segment data. These audio-visual features are a vector sequence in which frame-unit information constituting the audio information and video information of the utterance segment is embedded. Note that AV-HuBERT is a model that extends HuBERT to enable feature extraction not only from audio information but also from video information. A model obtained by pre-training this AV-HuBERT with large-scale audio information and video information is used, and the output of the Transformer Encoder inside the model is utilized as features in which video and audio are blended. Note that the Transformer Encoder represents the encoder portion of the Transformer model, an encoder-decoder model composed solely of attention mechanisms proposed as a model for performing machine translation. Then, the multimodal feature extractor interacts the text features and the audio-visual features through the Co-attention Transformer Layer (described below) of VILBERT (described below), thereby outputting multimodal features in which the features of three modalities, text information, audio information, and video information, are blended.

In addition, for example, the multimodal feature extractor uses the Co-attention Transformer Layer used in the well-known machine learning model VILBERT (short for Vision-and-Language BERT) to output multimodal features in which the features of three modalities, text information, audio information, and video information, are blended, from a combination of the features related to text information output from ALBERT and the features related to audio information and video information output from AV-HuBERT. Note that VILBERT is a model that exhibits high performance in well-known tasks such as Visual Question Answering (VQA) and Visual Commonsense Reasoning (VCR) by performing interaction between image and text features through the Co-attention Transformer Layer (a technique for computing attention mutually between image features and text features). Visual Question Answering is a task of deriving a correct answer when an image and a question about that image are presented. Visual Commonsense Reasoning is a task of deriving the correct answer and its basis from a question about an image and choices of answers.

As illustrated in FIG. 6, the multimodal features thus obtained are input to the complex feature model or the simple feature model of the score measurement unit 133. Note that multimodal features may also be obtained from combinations of input data other than those described above using pre-trained models as described above. Furthermore, different feature extractors may be used for each of text information, audio information, and video information to fuse features of different modalities in multiple stages as described above, or multimodal features may be extracted from a single trained model pre-trained on large-scale data comprising text information, audio information, and video information.

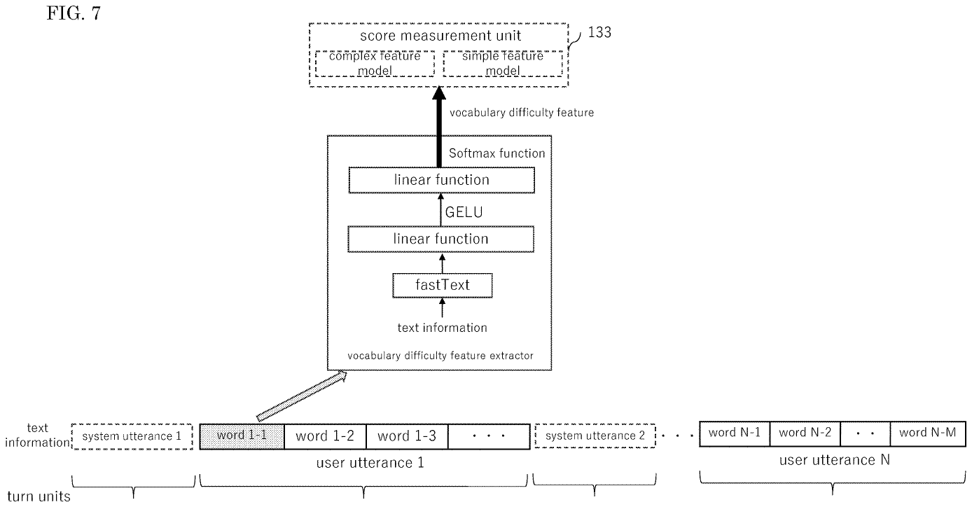

The feature extractor that extracts vocabulary difficulty features, i.e., the vocabulary difficulty feature extractor, will be described with reference to FIG. 7. FIG. 7 is a diagram showing an example of the vocabulary difficulty feature extractor. The portion enclosed by a solid line near the center of FIG. 7 is the vocabulary difficulty feature extractor, and the portion enclosed by a dotted line is the score measurement unit 133. As illustrated in FIG. 7, the vocabulary difficulty feature extractor takes text information contained in the input data as input, and outputs, as vocabulary difficulty features, features that quantify the difficulty level of words and phrases (words and phrases) contained in the user utterance.

The form of input data to the vocabulary difficulty feature extractor and the vocabulary difficulty feature extraction process will be described. When the input data is a conversation between a conversational agent and a user, the text information contained in the input data may take a form in which system utterances, which are utterances by the conversational agent, and user utterances appear alternately. FIG. 7 illustrates this form; specifically, it indicates that system utterance 1, user utterance 1, system utterance 2, . . . , user utterance N (N is an integer equal to or greater than 1) occur sequentially in the conversation.

As illustrated in FIG. 7, a user utterance consists of one or more words. To quantify the difficulty level of words, the vocabulary difficulty feature extractor receives input in word units and in the order they were uttered. That is, word 1-1 is first input to the multimodal feature extractor, then word 1-2 is input, and finally word N-M is input. Note that the input to the vocabulary difficulty feature extractor is not limited to words and may include phrases consisting of one or more words.

The vocabulary difficulty feature extractor trains a model to predict CEFR levels (CEFR levels) using the well-known models Word2Vec, GloVe (Global Vectors), or fastText, which are pre-trained using distributed representations of words (large-scale text and audio). fastText is a well-known pre-trained model that has been trained on large-scale text on the web and is publicly available. Specifically, when input data is input to the vocabulary difficulty feature extractor in the form described above, the vocabulary difficulty feature extractor trains the above model using the English Vocabulary Profile (EVP), to which CEFR levels have been assigned to the meanings of English words and phrases, or a well-known Japanese vocabulary list for language education that assigns levels ranging from elementary beginning to advanced ending for Japanese vocabulary. Note that the above-mentioned English Vocabulary Profile is a dictionary in which CEFR levels are assigned to the meanings of words and phrases.

As illustrated in FIG. 7, the vocabulary difficulty feature extractor inputs the output of a model such as fastText into a linear function, passes it through the well-known GELU (Gaussian Error Linear Units), inputs it to an activation function, and outputs through a Softmax function (Softmax function) a vector of predicted probabilities corresponding to the CEFR level (e.g., (0.1, 0.3, . . . , 0.2)) as vocabulary difficulty features. The predicted probability is the probability predicted by the model. The vocabulary difficulty features output by the vocabulary difficulty feature extractor are input to the score measurement unit 133. For example, the weights of the above linear function are pre-trained using the English Vocabulary Profile. Note that when a word is polysemous, the lowest level among the word meanings may be used as the correct level for learning purposes.

In this manner, the features output by the vocabulary difficulty feature extractor include vocabulary difficulty features, which are features that quantify the difficulty level of words and phrases contained in the user utterance. When a word or phrase is polysemous and the level differs for each meaning (e.g., for the English word “support,” the meaning “to help” is B1 but the meaning “to endorse” is B2), well-known word sense disambiguation may be performed to identify the specific meaning and obtain a feature corresponding to that meaning. Word sense disambiguation is a task of determining the meaning (sense) in which a word or phrase appearing in a sentence is used in that context. As a technique, for example, there is a model such as T5 (Text-to-Text Transfer Transformer) that has been trained to generate the correct meaning definition from the definition list, taking as input the contextual text, the target word or phrase in the sentence for which word sense disambiguation is to be performed, and a list of definitions for that word or phrase. In addition, the predicted probability or intermediate layer output vector of the above model may be obtained as vocabulary difficulty features for a word, or a vector sequence compiled per turn (the time from when a speaker begins talking until the conversation turn passes to the other party) from these vectors may be obtained as vocabulary difficulty features. Note that the vocabulary difficulty feature extractor may also take audio information and video information contained in the input data as input.

The feature extractor that extracts grammatical error features, i.e., the grammatical error feature extractor, will be described. The grammatical error feature extractor takes as input text information contained in input data divided into sentence units, identifies grammatical errors in the user utterance, and outputs features that quantify information about the grammatical errors as grammatical error features. For example, the grammatical error feature extractor may utilize GECTOR (Grammatical Error Correction: Tag, Not Rewrite) as a grammatical error corrector and obtain the output of the final layer of ROBERTa (Robustly optimized BERT approach) used internally in GECTOR (a word-unit vector sequence) as grammatical error features. GECTOR is a model that solves grammatical error correction as sequence labeling. ROBERTa is a model that improves upon BERT by introducing mechanisms such as dynamically changing the words to be masked according to learning progress in the task of predicting masked words performed in BERT. In addition, the grammatical error feature extractor may also take audio information and video information contained in the input data as input. In this manner, the features output by the grammatical error feature extractor include grammatical error features, which are features that quantify information about grammatical errors.

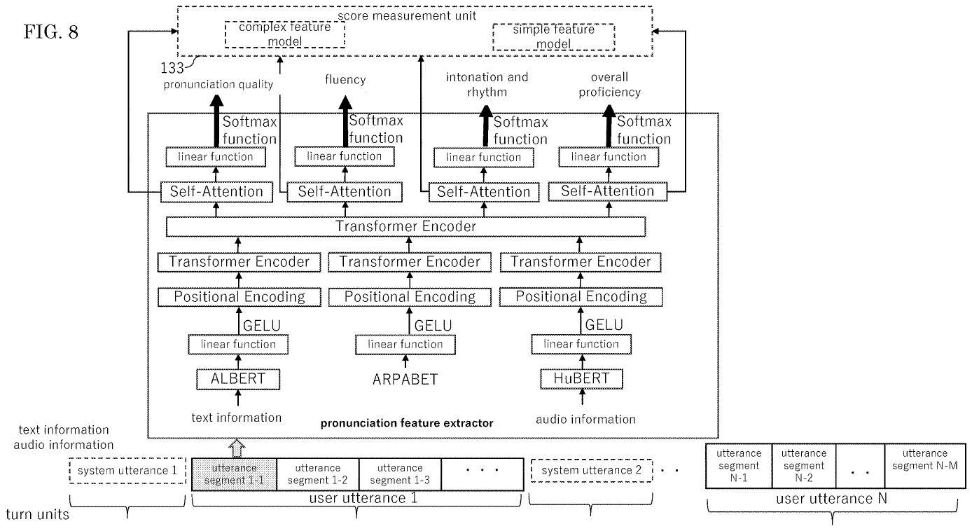

The feature extractor that extracts pronunciation features, i.e., the pronunciation feature extractor, will be described with reference to FIG. 8. FIG. 8 is a diagram showing an example of the pronunciation feature extractor. The portion enclosed by a solid line in the center of FIG. 8 is the pronunciation feature extractor, and the portion enclosed by a dotted line is the score measurement unit 133. As illustrated in FIG. 8, the pronunciation feature extractor takes audio information contained in the input data as input, and outputs as pronunciation features features that quantify the quality of pronunciation of audio uttered by the user. By way of example, pronunciation features are pronunciation accuracy, pronunciation fluency, intonation and rhythm, and overall pronunciation quality.

The form of input data to the pronunciation feature extractor and the pronunciation feature extraction process will be described. The form of input data is the same as for the multimodal feature extractor, utterance data among the input data is input in utterance segment units and in the order it was uttered.

When input data is input to the pronunciation feature extractor in the form described above, the pronunciation feature extractor first extracts text features (word-unit vector sequences) from text information contained in the input data using ALBERT, the well-known learning model. The pronunciation feature extractor also extracts, as features of phonemes that should originally be uttered, phoneme symbol sequences (e.g., the well-known ARPABET or IPA (International Phonetic Alphabet)) obtained by converting the text information. The extracted phoneme symbol sequences are converted in chronological order into one-hot vectors (vectors in which the dimension corresponding to the applicable phoneme symbol is 1 and all others are 0), and the entire phoneme symbol sequence compiled as a vector sequence is used as a feature related to phoneme symbols (phoneme features).

In addition, the pronunciation feature extractor extracts audio features from audio information contained in the input data using HuBERT, a well-known pre-trained model. Note that HuBERT is a model trained on large-scale audio data in a task that masks a portion of audio and predicts the pseudo-label (a label obtained by clustering) of the masked audio. Then, the pronunciation feature extractor is constructed by training the model shown in FIG. 8 to predict pronunciation accuracy, pronunciation fluency, quality of intonation and rhythm, and overall pronunciation quality from the text features, phoneme features, and audio features using datasets described below. In addition, the pronunciation feature extractor may also take video information contained in the input data as input.

In the above model of the pronunciation feature extractor, for example, the well-known speechocean762 dataset is used to train the model. In the case of speechocean762, 11-level scores are annotated for English speech audio by non-native speakers. The model is trained using a loss function similar to that of the complex feature model (described later) so as to maximize the evaluation metric Quadratic Weighted Kappa (QWK), and the intermediate layer output (the output of Self-Attention in FIG. 8) may be obtained as pronunciation features.

As illustrated in FIG. 8, the pronunciation feature extractor generates pronunciation features from the above-mentioned text features, phoneme features, and audio features through the processing steps described below. Specifically, the extracted pronunciation features are each input to a linear function, passed through the well-known GELU, and then positional information in the sequence is added by Positional Encoding. Note that Positional Encoding is a process of adding positional information to an input token sequence so as to uniquely distinguish at which position in the sequence each token is located.

Furthermore, the pronunciation feature extractor inputs the output from Positional Encoding to a Transformer Encoder. The respective outputs from the Transformer Encoder then interact with information obtained from the text features, phoneme features, and audio features through the Transformer Encoder. As a result, a vector sequence is output from the Transformer Layer, and this vector sequence is converted into a single vector by the well-known Self-Attention. Note that Self-Attention is a technique for computing, in a target vector sequence, how much attention should be paid by a given vector in that vector sequence to other vectors. The pronunciation feature extractor inputs the output from Self-Attention to a linear function and applies the Softmax function.

The pronunciation feature extractor outputs, through the Softmax function described above, predicted probabilities for each of the 11-level labels (label 0, . . . , label 10) annotated in speechocean762 (note that label 0 indicates the poorest pronunciation) for pronunciation accuracy, pronunciation fluency, intonation and rhythm, and overall pronunciation quality. In the present system, vectors output from each of the four Self-Attention units illustrated in FIG. 8 are used as pronunciation features and input to the complex feature model or the simple feature model of the score measurement unit 133. Note that the predicted probabilities, which are the final output of the model, may also be used as pronunciation features and input to the complex feature model or the simple feature model of the score measurement unit 133. In this manner, the features output by the pronunciation feature extractor include pronunciation features, which are features that quantify the pronunciation quality of audio uttered by the user.

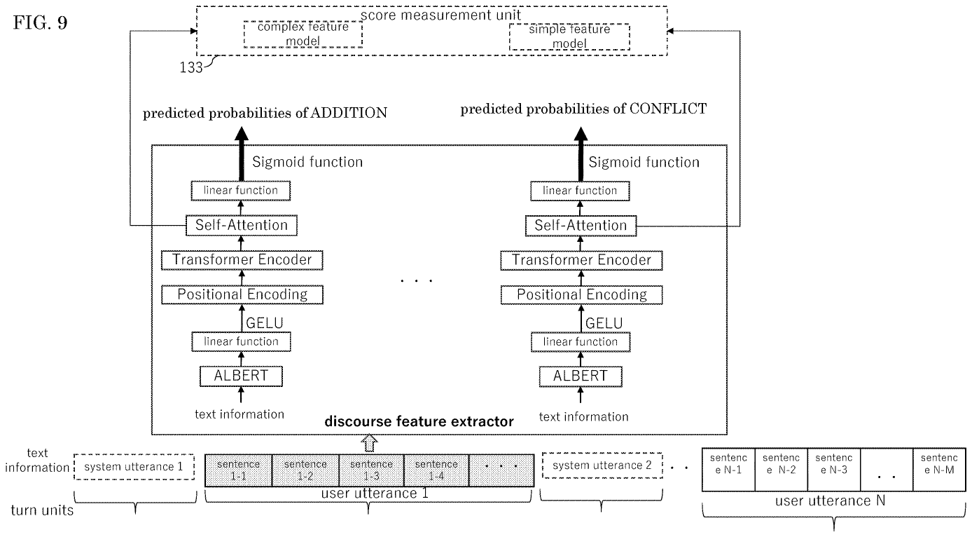

The feature extractor that extracts discourse features, i.e., the discourse feature extractor, will be described with reference to FIG. 9. FIG. 9 is a diagram showing an example of the discourse feature extractor. The discourse feature extractor takes as input text information contained in a conversation (conversation data) between a user and a conversational agent, and outputs discourse features. Discourse features are, by way of example, features that quantify prosodic, lexical, syntactic, semantic, functional, social, or stylistic features at the discourse level spanning a plurality of sentences or clauses. Note that the discourse feature extractor may output a plurality of types of discoursal features as discourse features. For example, the discourse feature extractor may output, as discourse features, the intermediate layer output of a model that predicts discourse markers (Discourse markers) that do not appear explicitly between sentences of a user utterance as illustrated in FIG. 9.

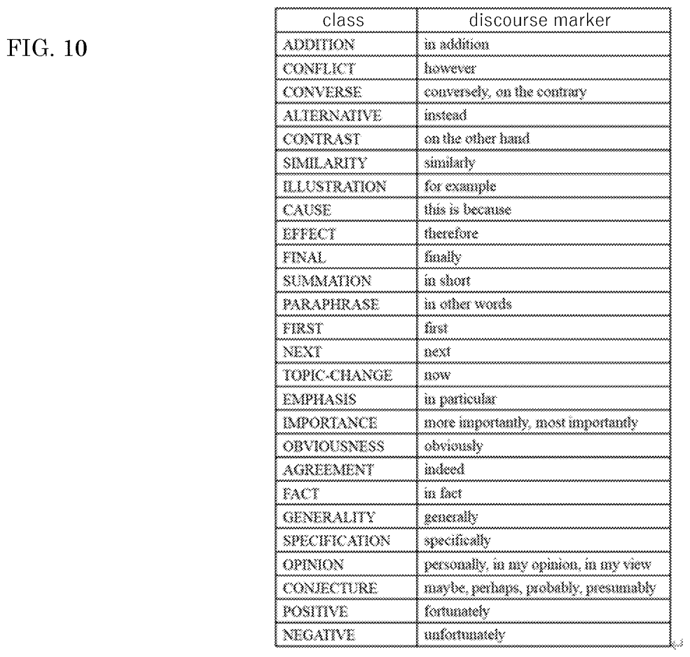

FIG. 10 is a diagram showing an example of a relationship between discourse markers and classes. The right column of FIG. 10 shows discourse markers, and the left column illustrates the class (class name) to which the discourse marker in the same row belongs. Discourse markers and classes will be described with reference to FIG. 10. A discourse marker is a marker used to prompt a listener to interpret the meaning of a message the speaker wishes to convey, and is classified, for example, into textual functions, informational functions, speech-act attitudinal functions, and interpersonal regulatory functions. For example, “in addition” with an additive function and “but” with a contrastive/adversative/contradictory/concessive function are classified under textual functions. The classes of discourse markers are the classifications illustrated in the left column of FIG. 10. For example, when the discourse marker is “in addition,” it is illustrated that the class of that discourse marker is “ADDITION” (additive function). In the present system, classes may be defined so as to cover discourse markers frequently used in large-scale text corpora. In this manner, the discourse feature extractor trains the model illustrated in FIG. 9 for each class of discourse marker by the method described below, and outputs the intermediate layer output of each model as discourse features.

The form of input data to the discourse feature extractor and the discourse feature extraction process will be described. The form of input data is one in which text information of user utterances divided by sentences is compiled in turn units. Note that input is not limited to user utterances; system utterances may also be input, and user utterances and system utterances spanning multiple turns may be input. In addition, the input data may include not only text information but also audio information and video information. Furthermore, text information may be text information after grammatical error correction. Additionally, the unit of segmentation of text information is not limited to sentences but may be clauses, phrases, or words. The discourse feature extractor may also take audio information and video information contained in the input data, as well as text information other than conversation, as input. In this manner, the features output by the discourse feature extractor include discourse features, which are features that quantify discourse-level linguistic phenomena in the conversation between the user and the conversational agent.

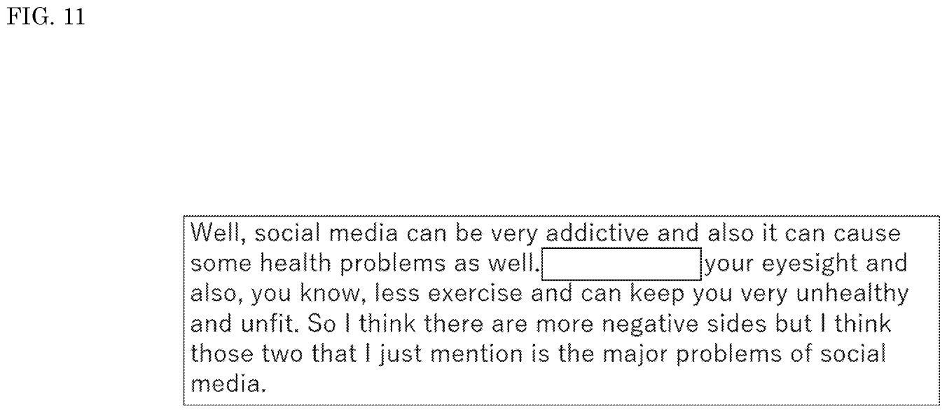

When input data is input to the discourse feature extractor in the form described above, the discourse feature extractor extracts text features (word-unit vector sequences) from text information contained in the input data using ALBERT, the well-known learning model. In the model for obtaining discourse features, by way of example, input is sentences in which discourse markers appearing in a well-known text corpus (see FIG. 10) have been masked. FIG. 11 is a diagram showing an example of a sentence in which a discourse marker between certain sentences has been masked. Sentences with part of the discourse marker masked will be described with reference to FIG. 11. In the present system, the model (the model illustrated in FIG. 9) is trained to predict the class of the masked discourse marker from the sentences existing before and after the masked portion. Specifically, when the text information contains the discourse markers illustrated in FIG. 10, the present system masks the discourse markers as illustrated in FIG. 11. In this manner, in the model for obtaining discourse features, the class of the applicable discourse marker is predicted from the sentences existing before and after the masked portion (the portion enclosed in a rectangle in FIG. 11). In FIG. 11, the masked discourse marker is “for example,” and the model is trained to predict “ILLUSTRATION,” which is the class of the discourse marker “for example,” from the sentences before and after the mask.

As illustrated in FIG. 9, the discourse feature extractor processes the discourse features extracted as described above for each class of discourse marker. Specifically, text features (word-unit vector sequences) extracted by ALBERT are input to a linear function, passed through the well-known GELU, and then positional information in the sequence is added by Positional Encoding. Furthermore, the pronunciation feature extractor inputs the output from Positional Encoding to a Transformer Encoder and interacts word-unit features through the Transformer Encoder. As a result, a vector sequence is output from the Transformer Encoder, and this vector sequence is converted into a single vector by the well-known Self-Attention. Then, the output from Self-Attention is input to a linear function, and a Sigmoid function (Sigmoid function) is applied.

The discourse feature extractor outputs the output vector of Self-Attention as discourse features. The predicted probability obtained through the Sigmoid function described above may also be used as discourse features. This trained model predicts the probability that two consecutive sentences in a user utterance can be connected by a specific discourse marker. In the present system, the predicted probabilities of vectors output from each of the Self-Attention units illustrated in FIG. 9 are output and input to the complex feature model or the simple feature model of the score measurement unit 133. By way of example, the present system has 26 discourse marker classes as shown in FIG. 10. Specifically, as illustrated in FIG. 9, the vectors output from each of the Self-Attention units are, for example, the output vectors of Self-Attention of the prediction model for 26 discourse marker classes regarding the intervals between sentence 1-1 and sentences 1-2, 1-3, and 1-4.

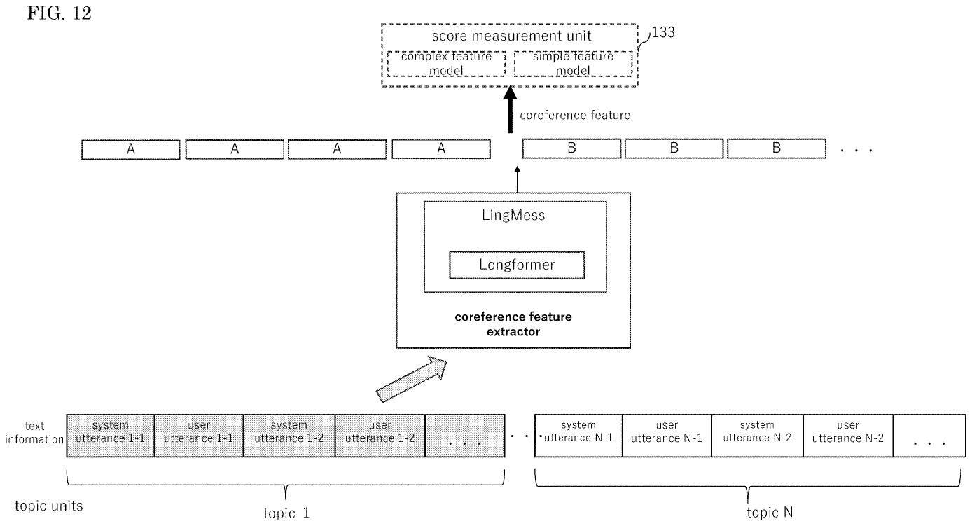

The feature extractor that extracts coreference features, i.e., the coreference feature extractor, will be described with reference to FIG. 12. FIG. 12 is a diagram showing an example of the coreference feature extractor. The coreference feature extractor takes as input text information contained in conversation between a user and a conversational agent on the same topic, and outputs coreference features. A topic is a subject such as “breakfast” or “travel” defined in a conversational scenario.

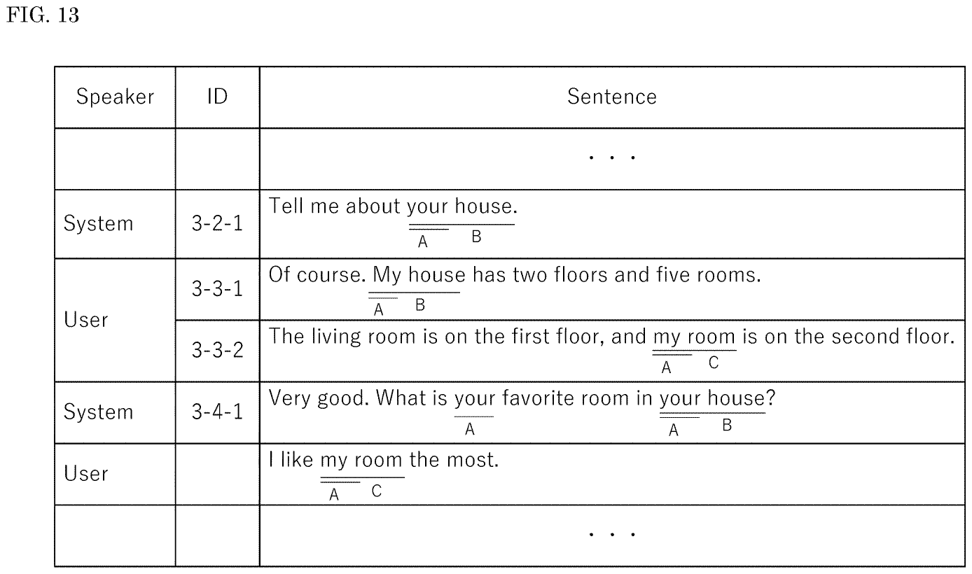

Coreference relations will be described with reference to FIG. 13. FIG. 13 is a diagram showing an example of coreference relations contained in a conversation between a user and a conversational agent. In FIG. 13, the “Speaker” column indicates the speaker; for example, “System” indicates that the speaker is the conversational agent, and “User” indicates that the speaker is the user. The “Sentence” column shows the text uttered by the speaker in the same row. The “ID” column shows the identifier of the text described in “Sentence” in the same row. For example, the sentence with “ID” “3-2-1” is “Tell me about your house,” and this sentence indicates that it was uttered by the conversational agent. Here, “ID” consists of topic number-turn number-sentence number, but is not limited thereto. Note that the text information of user utterances that is input may be text information after grammatical error correction.

In FIG. 13, “your” with reference symbol A in the utterance by the conversational agent and “m(M)y” with reference symbol A in the utterance by the user refer to the same object. Also in FIG. 13, “your house” with reference symbol B in the utterance by the conversational agent and “My house” with reference symbol B in the utterance by the user refer to the same object. Also in FIG. 13, the two occurrences of “my room” with reference symbol C in the utterance by the user refer to the same object. Such a pair (set) of words and phrases referring to the same object is called a coreference relation. The coreference feature extractor identifies pairs of words and phrases in a coreference relation (reference symbols A, B, C in FIG. 13), and outputs features that quantify the identified coreference relations as coreference features.

The form of input data to the coreference feature extractor and the coreference feature extractor will be described. As illustrated in FIG. 12, the input data to the coreference feature extractor is a combination of system utterances and user utterances in topic units.

The coreference feature extractor trains a coreference analysis model (e.g., LingMess) that estimates coreference relations between words and phrases, using a dataset annotated with coreference relations. Note that the well-known LingMess is a model that achieves high coreference analysis performance by training, for each category such as the relation between a pronoun and a pronoun or the relation between a proper noun and a pronoun, a function that determines whether a coreference relation holds between two words or phrases appearing in a sentence, and at inference time, using different functions depending on which category the two words or phrases belong to. The coreference feature extractor outputs coreference features using this trained coreference analysis model. In addition, the coreference feature extractor may also take audio information and video information contained in the input data as input. In this manner, the features output by the coreference feature extractor include coreference features, which are features obtained by identifying coreference relations between words and phrases in the conversation between the user and the conversational agent.

In addition, the coreference feature extractor may take as input, in addition to text information transcribing the content uttered by the conversational agent, text information of the user utterance after grammatical error correction, and may output, in order of appearance, the set of embedding representations (e.g., the output of the final layer of the well-known Longformer used internally in LingMess) of words and phrases (word sequences) in coreference relations identified by the above-mentioned coreference analysis model. An embedding representation is a representation of a symbol such as a word as a high-dimensional real-valued vector. Note that Longformer is a model improved to be able to process longer texts compared to BERT and the like.

Here, in the above-mentioned LingMess, word embedding representations of Longformer are utilized. Specifically, in LingMess, after identifying words and phrases in coreference relations such as reference symbols A, B, and C illustrated in FIG. 13 in the output of LingMess, the word embedding representations of the corresponding words and phrases are obtained from Longformer inside LingMess. In this case, when a word or phrase consists of a plurality of words, the embedding representations of each word constituting the word or phrase are summed to create a single vector representation.

The feature extractor that extracts commonsense features, i.e., the commonsense feature extractor, will be described. The commonsense feature extractor takes as input text information of user utterances and outputs commonsense features. Commonsense features are features obtained when a human with common sense infers the intentions or personality of the subject person from a user utterance. For example, if there is an utterance “I went to a convenience store,” the intention of the subject person can be inferred as “they wanted to buy something.” Also, from the utterance “I made coffee for a tired colleague,” the personality of the subject person can be inferred as “they are considerate.” Note that the commonsense feature extractor may take the text information of user utterances as-is (without processing) as input, or may take as input text information that has been subjected to grammatical error correction and divided into sentence units as preprocessing.

For example, the commonsense feature extractor trains a well-known commonsense reasoning model such as COMET using a dataset annotated with the above-mentioned inferential (reasoning) relations, and outputs commonsense features using the pre-trained commonsense reasoning model. In this manner, the features output by the commonsense feature extractor are features obtained when a human with common sense infers the intentions or personality of the subject person from a user utterance. By way of example, the commonsense feature extractor may train a commonsense reasoning model using a knowledge graph such as the well-known ATOMIC as a dataset, and output the intermediate layer output of the trained commonsense reasoning model as commonsense features. Note that ATOMIC is a database that describes, in an if-then relationship, everyday commonsense inferential knowledge such as: when person X and person Y have a conversation and X compliments Y, Y is likely to return the compliment to X. COMET is a model in which Transformer is trained to output the “then” text (Y will return the compliment to X) in response to the input of the “if” text (X complimented Y) using data such as ATOMIC.

The feature extractor that extracts manually designed features, i.e., the manually designed feature extractor, will be described. The manually designed feature extractor takes as input text information and audio information of utterances by the conversational agent and corresponding user utterances in turn units, and outputs manually designed features. Manually designed features are features designed based on expert human knowledge. The manually designed feature extractor obtains manually designed features based on, for example, knowledge from second language acquisition research. For example, for fluency, the utterance length, pause duration, number of words uttered per second, and number of fillers (e.g., “uh,” “um”) are extracted, and manually designed features are obtained based on these. Also, for example, for range of vocabulary, a dictionary in which words and phrases have been assigned levels is prepared, and the frequency and proportion of words and phrases at each level contained in the user utterance are extracted, and manually designed features are obtained based on these. Also, for example, for coherence, the frequency and proportion of discourse markers appearing in the user utterance are calculated, and manually designed features are obtained based on these. In this manner, the features output by the manually designed feature extractor include manually designed features, which are features designed based on expert human knowledge.

Note that when the linguistic feature extraction unit 131 outputs linguistic features in multiple languages, it may comprise different feature extractors for each language and extract linguistic features taking as input multilingual input data; alternatively, it may extract linguistic features from a common feature extractor using a model pre-trained on a large-scale multilingual dataset. In this case, the input data may be data consisting of a single language or data in which a plurality of languages coexist. For example, when it is desired to measure the ability to switch between multiple languages according to the situation (plurilingual ability), a situation in which multiple languages coexist within the same conversational task may be assumed.

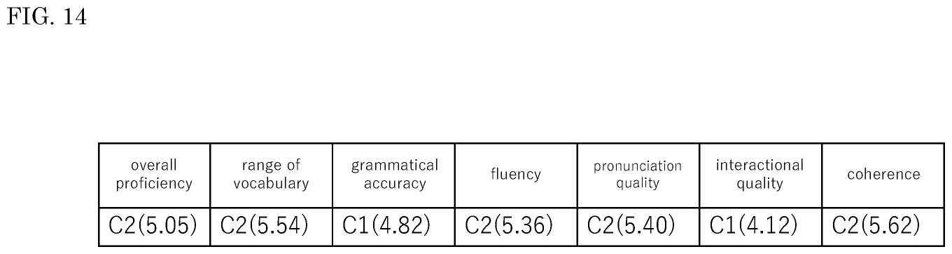

Returning to FIG. 4, the language proficiency measurement unit 132 will be described. Referring to FIG. 5, the language proficiency measurement unit 132 takes as input the linguistic features extracted by the linguistic feature extraction unit 131, and outputs a score and the basis for the score. The score is a quantification of the user's language proficiency for a specific index (e.g., range of vocabulary, grammatical accuracy, fluency), and is predefined by the service provider or system designer, but is not limited thereto. The index and the score will be described in detail later with reference to FIG. 14.

The language proficiency measurement unit 132 comprises the score measurement unit 133 and the basis extraction unit 134. The score measurement unit 133 takes as input the linguistic features extracted by the linguistic feature extraction unit 131 and outputs a score. For example, the language proficiency measurement unit 132 performs score measurement based on a predetermined index by inputting the output value of the linguistic feature extraction unit 131 into a machine learning model for score measurement (a score measurement machine learning model). As illustrated in FIG. 5, in the language proficiency measurement unit 132, the process of learning and evaluation is executed among a human evaluator, the complex feature model, and the simple feature model, thereby improving the prediction accuracy of the score measurement machine learning model. Note that the algorithm for converting linguistic features into scores may be a statistical technique or may be rule-based.

Before describing the functional configuration of the score measurement unit 133, the scores for each index obtained by the score measurement unit 133 will be described with reference to FIG. 14. FIG. 14 is a diagram showing an example of scores for each index obtained by the score measurement unit 133. The upper part of FIG. 14 shows the indexes, and the lower part shows the user's scores for each index. When using CEFR as an index in the present system, the score measurement unit 133, by way of example as illustrated in FIG. 14, obtains the user's score for each of seven indexes: range of vocabulary (Range), grammatical accuracy (Accuracy), fluency (Fluency), pronunciation quality (Phonology), interactional quality (Interaction), coherence (Coherence), and overall proficiency (Overall).

As illustrated in the lower part of FIG. 14, the score measurement unit 133 obtains both a CEFR level (discrete score) and a continuous value score (shown in parentheses in FIG. 14) as scores. In the present system, by way of example, a CEFR level is represented by one of the discrete scores A1, A2, B1, B2, C1, and C2. This notation is based on the well-known CEFR level notation. A1 is the lowest CEFR level and C2 is the highest CEFR level, indicating that proficiency for the applicable index is higher from A1 through C2. Also, by way of example, a continuous value score is expressed as a number between 0 and 6 (with two decimal places), indicating that proficiency is higher from 0 through 6. Note that the above continuous value scores are merely examples and are not limited to two decimal places.

There is a correlation between CEFR levels and continuous value scores; when the continuous value score is between 0.00 and 1.00 the CEFR level is defined as A1, when between 1.01 and 2.00 the CEFR level is A2, when between 2.01 and 3.00 the CEFR level is B1, when between 3.01 and 4.00 the CEFR level is B2, when between 4.01 and 5.00 the CEFR level is C1, and when between 5.01 and 6.00 the CEFR level is C2, but this is not limiting. FIG. 14 indicates that the user's CEFR level (discrete score) for the range of vocabulary index is C2, and the discrete score is 5.54.

Also, in the present system, the language proficiency measurement unit 132 may output both the CEFR level and the discrete score, or may output either one. In addition, the score output by the language proficiency measurement unit 132 may be a continuous value of a regression problem, a probability of a classification problem, or a discrete value indicating a specific level or category ID. For example, when using CEFR levels as an index, A1 may be defined as 0-1, A2 as 1-2, . . . , C2 as 5-6, and a continuous value such as 1.2 annotated by a human may be used as the correct value to estimate that continuous value using a regression model; alternatively, discrete labels annotated by humans such as A1, A2, . . . , C2 may be expressed as one-hot vectors such as A1=[1,0,0,0,0,0], A2=[0,1,0,0,0,0], . . . , C2=[0,0,0,0,0,1], the probability of each label may be predicted by a Softmax function, and the CEFR level with the highest probability (the CEFR level with the highest probability among A1, A2, B1, B2, C1, C2) may be used as the score.

Additionally, the language proficiency measurement unit 132 may decompose a multi-class classification problem into well-known One-vs-Rest (one-versus-all) binary classification problems (e.g., A1 vs. other CEFR levels) to obtain a score. The language proficiency measurement unit 132 may also decompose a multi-class classification problem into well-known One-vs-One (one-versus-one) binary classification problems (e.g., A1 vs. A2) to obtain a score. When a machine learning technique is used as the algorithm, a configuration may be adopted in which a model is provided for each index, or a configuration may be adopted in which scores for a plurality of indexes are output by a single model through multi-task learning. Furthermore, the final score is not limited to the output of a single trained model, and may be the output of an ensemble learning model in which the output of that model is further used as input to another model.

Also, in the present system, the index is not limited to CEFR, and may be the degree of familiarity (rapport) between the interlocutor and the user. In that case, the interlocutor may be a human, or an agent or robot equipped with a program. The index may also be a personality characteristic of the user, such as the well-known Big Five (Five-Factor Model of personality).

The functional configuration of the score measurement unit 133 will be described with reference to FIG. 5. As illustrated in FIG. 5, the score measurement unit 133 comprises, as machine learning models for score measurement, a complex feature model and a simple feature model, and further comprises a score converter.

The complex feature model is a machine learning model that predicts scores using various linguistic features extracted by the linguistic feature extraction unit 131. Also, as illustrated in FIG. 5, in the present system, a human evaluator checks whether the output of the score measurement unit 133, that is, the output of the complex feature model or the simple feature model, is correct. By way of example, the human evaluator views a video of the user and conversational agent in conversation and annotates, for each of the seven CEFR indexes (range of vocabulary, grammatical accuracy, fluency, pronunciation quality, interactional quality, coherence, and overall proficiency), CEFR levels from A1 to C2 as scores. Continuous value scores may also be annotated for each of the seven CEFR indexes described above. In addition, the human evaluator may annotate only the output of a specific index.

Here, a measure that quantifies how reliable the output of the score measurement unit 133 is is defined as the confidence level. A well-known technique may be used to calculate the confidence level so that a human evaluator preferentially checks pairs of input data and outputs with low confidence levels. By way of example, the probability distribution when a prediction (prediction result) by the complex feature model was correct and the probability distribution when it was not correct may be obtained, and the confidence level may be calculated based on the ratio of how much a new prediction (prediction result) belongs to each probability distribution. Also, as illustrated in FIG. 5, in the present system the human evaluator checks the output of the complex feature model or the simple feature model, but the system may operate without (or without the intervention of) a human evaluator, taking the output of the complex feature model or the simple feature model as the correct answer.

The learning of the complex feature model will be described. The initial model of the complex feature model in the first cycle, as described above, is trained to predict the CEFR levels (A1 to C2; correct answers) annotated by human evaluators for conversation data between the user and the conversational agent. That is, the initial model of the complex feature model is trained on training data (datasets) in which human evaluators have reviewed input data and annotated correct answers.

From the second cycle onward, if an error is found in the output of the complex feature model during the confirmation process by the human evaluator, the human evaluator annotates the correct score and adds it to the training data. Note that annotation data added to the training data is not limited to annotation data with errors corrected; even when a human reviews the output of the complex feature model and the result was correct, the score evaluated as correct by the human may be newly added to the training data (dataset). The complex feature model is retrained using the newly added training data. In retraining, the trained model may be fine-tuned using only the newly annotated data, or the model may be retrained from scratch using a dataset that adds the newly annotated data to the existing training data.

In the present system, the complex feature model and the simple feature model (hereinafter, the score measurement machine learning model) shall be trained using a loss function to predict the CEFR levels annotated by human evaluators from input data. This loss function will be described. In the score measurement machine learning model, training is performed using a loss function to predict the CEFR levels annotated by human evaluators. In the present system, a well-known cost-sensitive loss function with a penalty term (LCS) is introduced as the loss function. This is because a case where the output of the score measurement machine learning model is C2 against a correct answer of A1 should incur a heavier penalty than a case where the output is A2. The cost-sensitive loss function will be described using Mathematical Formula 1 through Mathematical Formula 4. The overall loss function (L) is obtained by Mathematical Formula 1.

$$L = {{\sum }_{k = 1}}^{N} {L}_{CS}^{k} \qquad [ Formula 1 ]$$

Here, Lcs is the cost-sensitive loss function. For multi-task learning, the sum of the loss functions (Lkcs) for each CEFR index is defined as the overall loss function (L). The loss function (Lcs) for each index is obtained by Mathematical Formula 2.

$${L}_{C S} = {L}_{FL} + α {{\sum }_{n = 1}}^{N} 〈 {M}^{β} ( {y}_{n} , \cdot ) , {p}_{n} 〉 \qquad [ Formula 2 ]$$

In Mathematical Formula 2, the cost-sensitive loss function (Lcs) is defined as the sum of Focal Loss (LFL, first term) and a cost term (second term). Here, LFL in the first term is the loss function Focal Loss (FL). In the second term, alpha is a hyperparameter that adjusts how much weight to give to the cost term (second term) relative to the base loss function Focal Loss. N is the number of samples in the training data. Mbeta is the cost matrix, which is described in detail in Mathematical Formula 4 below. Mbeta(yn, ⋅) represents the operation of obtaining the cost vector of row yn of the cost matrix Mbeta. yn represents the index of the correct class for sample n. For example, if yn is 1 it represents A1, and if yn is 2 it represents A2. pn represents a C-dimensional vector of predicted probabilities, where the first dimension is the predicted probability for A1 and the second dimension is the predicted probability for A2. <Mbeta(yn, ⋅), pn> represents the inner product of the cost vector when the correct answer is yn and the predicted probability vector pn. In the present system, Focal Loss is used to enable training with increased importance placed on samples that are difficult to classify, such as classes with a small number of samples, but is not limited thereto. Focal Loss (LFL) is obtained by Mathematical Formula 3.

$${L}_{FL} = - {{\sum }_{n = 1}}^{N} {{\sum }_{c = 1}}^{C} {{y}_{nc} ( 1 - {p}_{nc} )}^{Υ} log ( {p}_{nc} ) \qquad [ Formula 3 ]$$

Mathematical Formula 3 defines that Focal Loss (LFL) is a loss function that extends the well-known loss function Cross Entropy Loss to be able to train with increased importance placed on samples that are difficult to classify, such as classes with a small number of samples. Here, N is the number of samples in the training data and C is the CEFR level (A1, A2, . . . , C2). Also, ync is the true probability that sample n belongs to class c; when the correct class of sample n is A2, yn1=0 (A1), yn2=1 (A2), . . . , yn6=0 (C2). Also, pnc is the value predicted by the model as the probability that sample n belongs to class c. Also, gamma is a hyperparameter that adjusts how much to reduce the importance of samples that are easy to classify. Mbetaij is also obtained by Mathematical Formula 3.

$${M}_{ij}^{β} = \frac{{\vert i - j \vert}^{β}}{{( C - 1 )}^{β}} \qquad [ Formula 4 ]$$

Mbetaij shown in Mathematical Formula 4 is a cost matrix for increasing the penalty according to the distance between classes. Beta is a hyperparameter that adjusts how much to increase the penalty according to distance. i and j are the distance between two classes, and the further the distance between classes, the larger the penalty. Specifically, when the correct answer is A1, the penalty for incorrectly predicting C2 is greater than the penalty for incorrectly predicting A2.

In the present system, the score measurement machine learning model is trained using the loss function obtained by Mathematical Formula 1 through Mathematical Formula 4. The trained model outputs, for each of the predicted probabilities for A1 through C2, values that sum to 1 for the input data. In the present system, by way of example, this weighted sum is used as the score.

In the present system, QWK is predetermined as the evaluation metric, and the score measurement unit 133 optimizes the boundaries for converting the above score into CEFR levels, namely, the boundary between A1 and A2, the boundary between A2 and B1, . . . , and the boundary between C1 and C2, so as to maximize QWK (so as to best match the classification criteria of human evaluators).

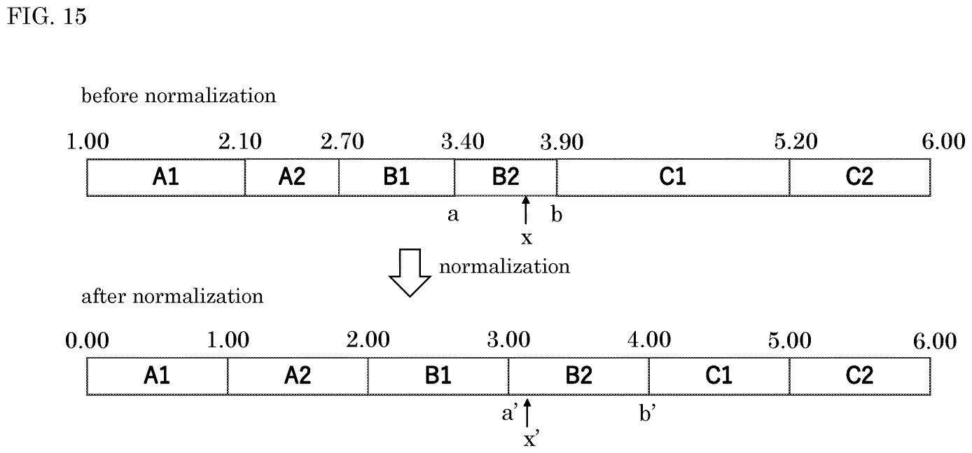

FIG. 15 is a diagram showing an example of a concept of a technique for normalizing scores in which the intervals between boundaries are unbalanced after the score boundaries have been optimized so that they become uniform. The normalization technique in the present system will be described with reference to FIG. 15. The upper part of FIG. 15 illustrates the relationship between CEFR levels and continuous value scores after adjustment to optimize score boundaries (before normalization), and the lower part illustrates the relationship between CEFR levels and continuous value scores after normalization. The relationship between CEFR levels and continuous value scores after normalization in the lower part of FIG. 15 is obtained by normalizing the relationship between CEFR levels and continuous value scores before normalization in the upper part so that the intervals between level boundaries are uniform.

Also, A1 to C2 in FIG. 15 are CEFR levels. Also, “a” in FIG. 15 is the boundary value (continuous value) between B1 and B2 before normalization, and “b” is the boundary value between B2 and C1 before normalization. Also, “a” in FIG. 15 is the boundary value between B1 and B2 after normalization, and “b′” is the boundary value between B2 and C1 after normalization. Also, “1.00,” “2.10,” etc. in FIG. 15 also illustrate the boundary values for each CEFR level before and after normalization. Also, “x” in FIG. 15 is the score before normalization, and “x” is the score after normalization. The user is presented with the score “x′” after normalization.

The processing of converting the probability vector output from the score measurement machine learning model into a score and normalizing the unbalanced boundary values is performed based on Mathematical Formula 5 through Mathematical Formula 7.

$$x = {{\sum }_{c = 1}}^{C} c \times {p}_{c} \qquad [ Formula 5 ]$$

Mathematical Formula 5 is an expression for converting the predicted probabilities (a 6-dimensional vector corresponding to CEFR levels A1 through C2) obtained from the output of the complex feature model or simple feature model into a score. C is the number of classes, i.e., the 6 classes of CEFR levels A1 through C2. pc represents the predicted probability for class c (CEFR level). pc satisfies Mathematical Formula 6.

$${{\sum }_{c = 1}}^{C} {p}_{c} = 1 \qquad [ Formula 6 ]$$

Mathematical Formula 6 indicates that the sum of predicted probabilities for each CEFR level obtained by the Softmax function of the complex feature model or the simple feature model is 1. The score “x′” obtained by normalizing the score “x” obtained by Mathematical Formula 5 using Mathematical Formula 7 is presented to the user.

$${x}^{′} = {b}^{′} - \frac{b - x}{b - a} \times ( {b}^{′} - {a}^{′} ) \qquad [ Formula 7 ]$$

Mathematical Formula 7 is a formula for uniformly normalizing the boundaries between levels that have become unbalanced by the above-described optimization process, and obtaining the normalized score. Note that the processing from Mathematical Formula 5 through Mathematical Formula 7 shall be performed by the score converter, but is not limited thereto.

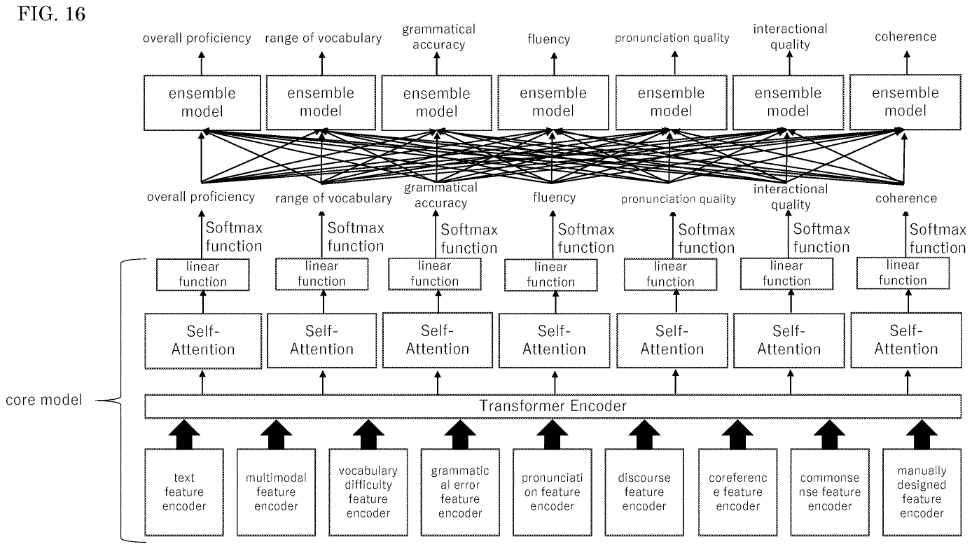

In the present system, by way of example, the score measurement unit 133 compares the output of the ensemble model (Ensemble Model) and the output of the core model (the configuration from each linguistic feature encoder to the Softmax function in FIG. 16) for each CEFR index, and adopts the output with higher performance. The ensemble model is a model obtained by combining the outputs for each index of the core model and performing well-known ensemble learning. By way of example, the ensemble model and core model of the complex feature model split the dataset annotated by human evaluators into a training set and a test set, train each model on the training set, and evaluate performance (QWK) on the test set. The QWK for each CEFR index on this test set is compared between the ensemble model and the core model; for example, for the range of vocabulary index, if the QWK of the ensemble model is greater than the QWK of the core model, the output of the ensemble model is adopted for the range of vocabulary index in operation. Also, for the fluency index, if the QWK of the core model is greater than the QWK of the ensemble model, the output of the core model is adopted for the fluency index in operation. Note that this is merely an example and is not limited to the above aspect.

In the present system, based on well-known Teacher-Student learning, the complex feature model is used as the Teacher model and the simple feature model is used as the Student model, and the simple feature model (Student model) is trained to reproduce (imitate, approximate) the output of the complex feature model (Teacher model). Note that the simple feature model (Student model) is lighter than the complex feature model (Teacher model). That is, the simple feature model has fewer parameters, smaller memory consumption during execution, and a shorter processing time from when the features are input until output is obtained, compared to the complex feature model. Furthermore, the features input to the simple feature model are not necessarily the same as those for the complex feature model, and features output from a feature extractor for the simple feature model may be input.

FIG. 16 is a diagram showing an example of a concept of the complex feature model of the score measurement unit 133. An example of the concept of the complex feature model of the score measurement unit 133 will be described with reference to FIG. 16. FIG. 16 illustrates a complex feature model comprising a core model having a structure in which outputs from respective encoders that encode various linguistic features are input to a well-known Transformer Encoder, interaction is taken between different types of linguistic features output from the respective encoders in that Transformer Encoder, and then a network specialized for prediction of each CEFR index (Self-Attention and linear function) is passed to predict the CEFR level for each index, and further comprising an ensemble model that receives the output of the core model and performs prediction of each index again.

When using CEFR as an index in the present system, the complex feature model, by way of example, comprises as various encoders: a text feature encoder (Interactive Text Feature Encoder), a multimodal feature encoder (Multimodal Feature Encoder), a vocabulary difficulty feature encoder (Vocabulary Difficulty Feature Encoder), a grammatical error feature encoder (Grammatical Error Feature Encoder), a pronunciation feature encoder (Pronunciation Feature Encoder), a discourse feature encoder (Discourse Feature Encoder), a coreference feature encoder (Coreference Feature Encoder), a commonsense feature encoder (Commonsense Feature Encoder), and a manually designed feature encoder (SLA Inspired Feature Encoder).

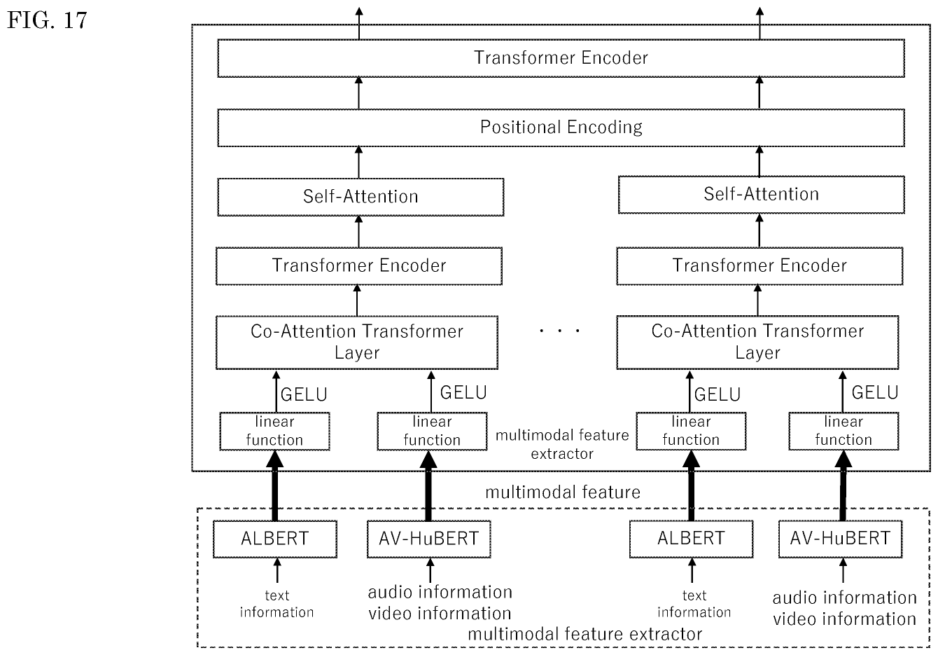

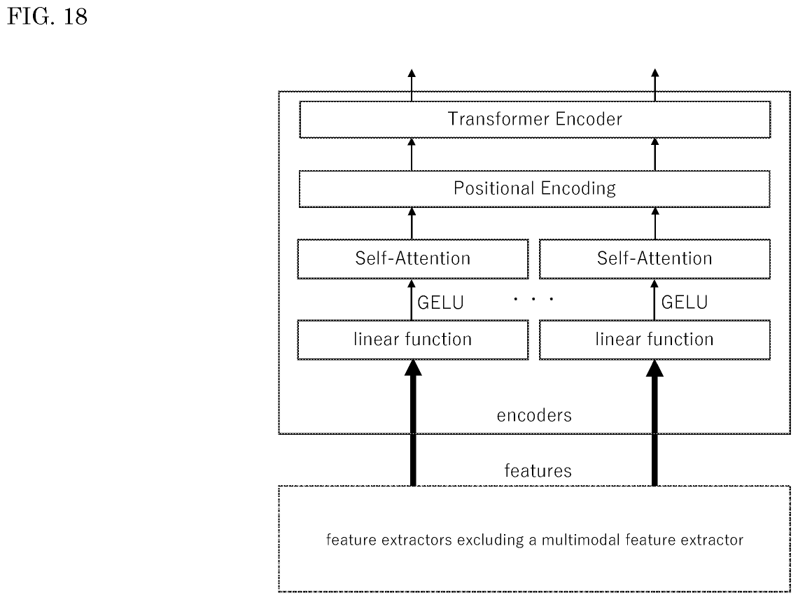

Each encoder of the score measurement unit 133 corresponds to each of the various feature extractors comprised in the linguistic feature extraction unit 131; for example, the output from the feature extractor that outputs text features is input to the text feature encoder. Each encoder is a network that receives the linguistic features output by the various feature extractors of the linguistic feature extraction unit 131, encodes each linguistic feature, and outputs a vector sequence. Each of these encoders will be described with reference to FIG. 17 and FIG. 18.

The multimodal feature encoder will be described with reference to FIG. 17. FIG. 17 is a diagram showing an example of a processing flow of the multimodal feature encoder. Note that the portion enclosed by a dotted line is the multimodal feature extractor of the linguistic feature extraction unit 131, and the portion enclosed by a solid line is the multimodal feature encoder of the complex feature model in the score measurement unit 133 (language proficiency measurement unit 132) (see FIG. 16). As described above with reference to FIG. 6, from the multimodal feature extractor, features related to input data (text information, audio information, and video information) divided into utterance segment units are input to the multimodal feature encoder chronologically. Note that the output from the topmost Transformer Encoder illustrated in FIG. 17 is input to the Transformer Encoder of the core model of the complex feature model illustrated in FIG. 16. The network weights of the multimodal feature encoder are updated during training of the complex feature model.

As illustrated in FIG. 17, the multimodal feature encoder inputs to a linear function the features related to text information (text features, i.e., word-unit vector sequences) obtained by ALBERT in the multimodal feature extractor of the linguistic feature extraction unit 131, and the features related to audio information and video information (audio-visual features, i.e., frame-unit vector sequences) obtained by AV-HuBERT. Here, the text features and the audio-visual features are converted into vectors of the same dimension. Thereafter, passing through the well-known activation function GELU, a vector sequence is obtained in which the text features and audio-visual features are made to interact through the above-described Co-attention Transformer Layer and a Transformer Encoder provided in the upper layer thereof.

Through the above-described process, the vector sequence obtained from the lower Transformer Encoder in FIG. 17 is converted into a single vector by the well-known Self-Attention. Through the processing up to this point, a vector is obtained in which the information of three modalities, text information, audio information, and video information, of the input utterance segment is fused. Thereafter, the vectors generated from each utterance data are input chronologically to the topmost Transformer Encoder in FIG. 17 while maintaining order by Positional Encoding. Through the processing up to and including this topmost Transformer Encoder, the multimodal feature encoder outputs a vector sequence in which features (vectors in which text information, audio information, and video information of utterance segments are embedded) obtained from different utterance segments have interacted with each other.

FIG. 18 is a diagram showing an example of a general processing flow of encoders other than the above-mentioned multimodal feature encoder. In FIG. 18, the portion enclosed by a dotted line represents feature extractors other than the multimodal feature extractor in the linguistic feature extraction unit 131, namely, the text feature extractor, vocabulary difficulty feature extractor, grammatical error feature extractor, pronunciation feature extractor, discourse feature extractor, coreference feature extractor, commonsense feature extractor, and manually designed feature extractor. The portion enclosed by a solid line is the configuration of encoders other than the multimodal feature encoder. These encoders are respectively, within the score measurement unit 133 (language proficiency measurement unit 132), encoders other than the multimodal feature encoder, namely, the text feature encoder, vocabulary difficulty feature encoder, grammatical error feature encoder, pronunciation feature encoder, vocabulary difficulty feature encoder, discourse feature encoder, coreference feature encoder, commonsense feature encoder, and manually designed feature encoder.

In the present system, interaction between features of the same type extracted from the same feature extractor takes place within each encoder. Specifically, interaction between features of the same type, if they are multimodal features, takes place in the topmost Transformer Encoder illustrated in FIG. 17, and if they are other features, takes place in the Transformer Encoder illustrated in FIG. 18. Interaction between different types of features extracted from different feature extractors takes place in the Transformer Encoder of the core model of the complex feature model in FIG. 16.

As illustrated in FIG. 18, encoders other than the multimodal feature encoder, namely, the text feature encoder, vocabulary difficulty feature encoder, grammatical error feature encoder, pronunciation feature encoder, discourse feature encoder, coreference feature encoder, commonsense feature encoder, and manually designed feature encoder, each receive data related to features from the corresponding feature extractor and input it to a linear function. Then, passing through the well-known GELU activation function, the vector sequence is input to the well-known Self-Attention. The vector output from Self-Attention is then subjected to Positional Encoding to add positional information, and thereafter input to a Transformer Encoder. Note that the output from the Transformer Encoder illustrated in FIG. 18 is input to the Transformer Encoder of the core model of the complex feature model illustrated in FIG. 16. The network weights of each encoder are updated during training of the complex feature model. Each encoder other than the multimodal feature encoder will be described.

The text feature encoder, as described above, receives text features output from the text feature extractor (specifically, a collection of word vector sequences obtained from all sentences by inputting sentences contained in system utterances and user utterances into the text feature extractor to obtain word vector sequences (output of ALBERT)), inputs the vector sequence to a linear function in chronological order, and after completing the processing up to Self-Attention, adds positional information by Positional Encoding, and interaction between features takes place in the Transformer Encoder. The network weights of the text feature encoder are updated during training of the complex feature model.

The vocabulary difficulty feature encoder, as described above, receives vocabulary difficulty features output from the vocabulary difficulty feature extractor (specifically, a collection of vector sequences obtained from all user utterances by compiling per-turn the outputs (vectors) of the vocabulary difficulty feature extractor for each word in the user utterance illustrated in FIG. 7 into a vector sequence), inputs the vector sequence to a linear function in chronological order, and after completing the processing up to Self-Attention, adds positional information by Positional Encoding, and interaction between features takes place in the Transformer Encoder. The network weights of the vocabulary difficulty feature encoder are updated during training of the complex feature model.

The grammatical error feature encoder, as described above, receives grammatical error features output from the grammatical error feature extractor (specifically, a collection of vector sequences obtained from all user utterance sentences by inputting sentences of user utterances into the grammatical error feature extractor to obtain word vector sequences (output of ROBERTa in GECTOR)), inputs the vector sequence to a linear function in chronological order, and after completing the processing up to Self-Attention, adds positional information by Positional Encoding, and interaction between features takes place in the Transformer Encoder. The network weights of the grammatical error feature encoder are updated during training of the complex feature model.

The pronunciation feature encoder, as described above, receives pronunciation features output from the pronunciation feature extractor (specifically, a collection of vector sequences obtained from all utterance segments using the outputs of Self-Attention illustrated in FIG. 8 (four vectors, i.e., a vector sequence)), inputs the vector sequence to a linear function in chronological order, and after completing the processing up to Self-Attention, adds positional information by Positional Encoding, and interaction between features takes place in the Transformer Encoder. The network weights of the pronunciation feature encoder are updated during training of the complex feature model.

The discourse feature encoder, as described above, receives discourse features output from the discourse feature extractor (specifically, a collection of vector sequences obtained from between all user utterance sentences using, as illustrated in FIG. 9, for example, the output vectors of Self-Attention (26 vectors, i.e., a vector sequence) when predicting the 26 discourse marker classes illustrated in FIG. 10 for the interval between sentence 1-1 and sentence 1-2), inputs the vector sequence to a linear function in chronological order, and after completing the processing up to Self-Attention, adds positional information by Positional Encoding, and interaction between features takes place in the Transformer Encoder. The network weights of the discourse feature encoder are updated during training of the complex feature model.

The coreference feature encoder will be described. The coreference feature encoder, as described above, receives coreference features output from the coreference feature extractor (specifically, as illustrated in FIG. 12, a collection of vector sequences obtained for all words and phrases in coreference relations by inputting topic-unit text information to the coreference feature extractor and compiling the embedding vectors of words and phrases (word sequences) in coreference relations identified by the coreference analysis model across the entire group of words and phrases in the same coreference relation into a vector sequence), inputs the vector sequence to a linear function in chronological order, and after completing the processing up to Self-Attention, adds positional information by Positional Encoding, and interaction between features takes place in the Transformer Encoder. The network weights of the coreference feature encoder are updated during training of the complex feature model.

The manually designed feature encoder will be described. The manually designed feature encoder, as described above, receives manually designed features output from the manually designed feature extractor (specifically, for example, in the case of the number of fillers, the number of fillers contained in the user utterance of a certain turn becomes the numerical value of a specific dimension of the vector, and similarly, vectors in which the numerical values for all dimensions of the vector are filled for all manually designed features are compiled for all turns of the same topic into a vector sequence, and this is further a collection of vector sequences obtained for all topics), inputs the vector sequence to a linear function in chronological order, and after completing the processing up to Self-Attention, adds positional information by Positional Encoding, and interaction between features takes place in the Transformer Encoder. The network weights of the manually designed feature encoder are updated during training of the complex feature model.

As illustrated in FIG. 16, the vector sequences output by the various encoders described above are input to the Transformer Encoder. The Transformer Encoder inputs to respective networks specialized for each CEFR index (combinations of Self-Attention and a linear function) vector sequences obtained through the mutual influence of linguistic features output from the various feature extractors. The network takes a vector sequence as input and uses a Softmax function to output the probability of each CEFR index level.

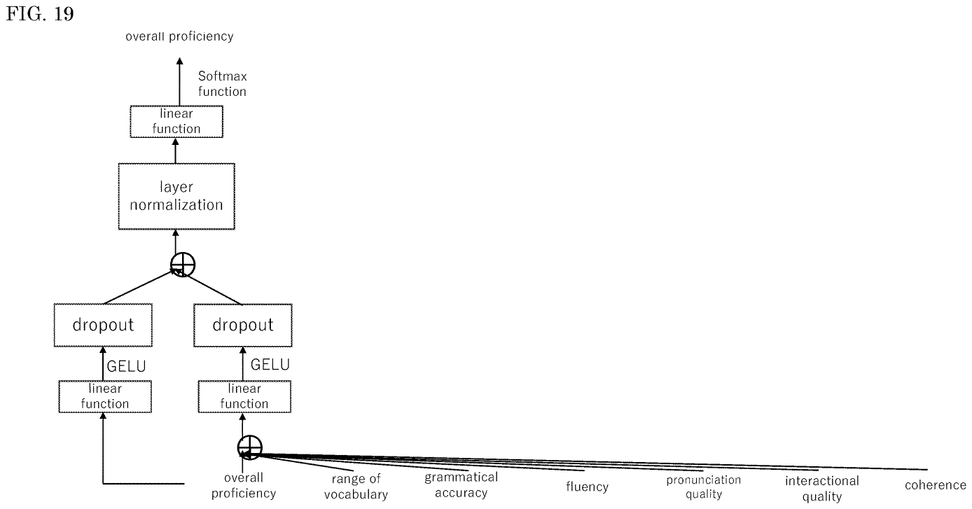

The ensemble model takes as input the predicted probabilities of each CEFR index level from the core model, and outputs a numerical value reconsidered by also taking into account the predicted probabilities of other CEFR indexes in the core model when predicting a specific CEFR index. FIG. 19 is a diagram showing an example of an ensemble model that outputs overall proficiency in the complex feature model. The processing flow of the ensemble model that outputs overall proficiency in the complex feature model of the score measurement unit 133 will be described with reference to FIG. 19. As illustrated in FIG. 19, the score measurement unit 133 of the present system combines the outputs for each index from the core model and recalculates the predicted probability of overall proficiency. For example, the score measurement unit 133 of the present system uses the above-described GELU activation function for the recalculated predicted probabilities and suppresses overfitting using well-known dropout. The score measurement unit 133 uses well-known layer normalization (Layer normalization) to normalize the mean and variance of the input data from dropout. The ensemble model finally applies the Softmax function to the output from the linear function and outputs the recalculated predicted probability of overall proficiency. The same ensemble model configuration is adopted for range of vocabulary, grammatical accuracy, and the like.

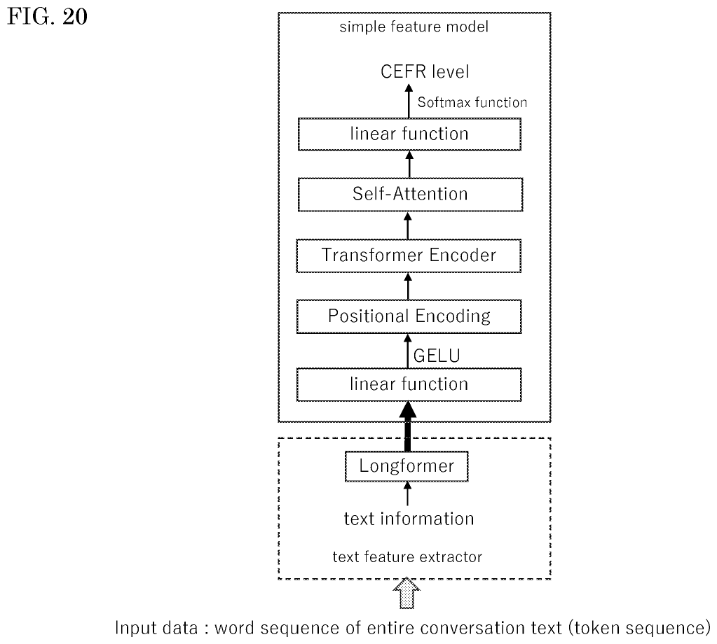

Returning to FIG. 5, the simple feature model of the score measurement unit 133 will be described with reference to FIG. 20. FIG. 20 is a diagram showing an example of a processing flow of the simple feature model. As illustrated in FIG. 16, while the complex feature model takes a wide variety of linguistic features as input and achieves high prediction performance by having them interact, the simple feature model takes a carefully selected set of features (e.g., only text features, or only specific features among manually designed features) as input and predicts the level for those. Also, the index to be predicted may be narrowed down to one. For example, there is a simple feature model that takes specific manually designed features effective for fluency as input and predicts only the CEFR level of fluency (Fluency). Specifically, FIG. 20 illustrates a simple feature model that predicts the range of vocabulary (Range) level (A1 to C2) in the CEFR indexes. The portion enclosed by a dotted line in FIG. 20 is the feature extractor of the simple feature model, i.e., the text feature extractor, and the portion enclosed by a solid line is the simple feature model. The feature extractor of the simple feature model takes as input the entire word sequence of conversation text between the conversational agent and user utterances and outputs the output of the final layer of Longformer (word-unit vector sequences) as linguistic features.

As illustrated in FIG. 20, the simple feature model inputs the linguistic features (word-unit vector sequences) output from the feature extractor of this simple feature model into a linear function. The well-known GELU is applied to the output from this linear function, positional information is added to the resulting vector sequence by Positional Encoding, and the sequence is then input to a Transformer Encoder. The vector sequence output from the Transformer Encoder is then converted into a single vector by the well-known Self-Attention. The simple feature model inputs the output from Self-Attention to a linear function and outputs the predicted probabilities of CEFR levels (A1, A2, . . . , C2) through a Softmax function.

In addition, the simple feature model may, as described above, be trained based on well-known Teacher-Student learning with the complex feature model as the Teacher model and the simple feature model as the Student model so as to reproduce (imitate, approximate) the output of the complex feature model (Teacher model), or may be trained on annotation data by human evaluators. The above-described confirmation process by human evaluators may also be applied to the simple feature model. Note that the simple feature model may be configured to output one index per model, or may be configured to output a plurality of indexes per model, i.e., a multi-task learning configuration. Note that the model configuration and algorithm are not limited thereto. In addition, the final output or intermediate layer output (e.g., the output of Self-Attention in FIG. 20) of the simple feature model may be used as a feature extractor of the complex feature model, or the simple feature model itself (e.g., the solid-line portion of FIG. 20) may be added as an encoder to the complex feature model.

The score converter converts the multidimensional probabilities (probabilities for each of A1, A2, . . . , C2) obtained in the complex feature model and the simple feature model into real number (scalar) scores. Note that please refer to the illustration in FIG. 14 for scores converted by the score converter.

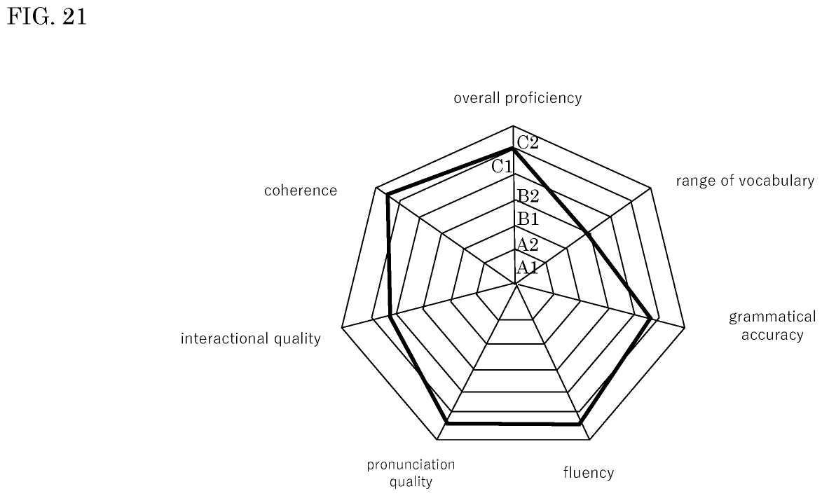

The basis extraction unit 134 takes as input linguistic features extracted by the score measurement unit 133 and the linguistic feature extraction unit 131, and outputs the basis for the score. The basis for the score will be described later with reference to FIG. 21 through FIG. 27. The basis extraction unit 134 references the simple feature model or the complex feature model and calculates the degree of contribution of each feature to the output score. For example, in a simple feature model that predicts the CEFR level of range of vocabulary (Range) using words as features, the basis is the degree of contribution of each word contained in the user utterance to the predicted probability of each CEFR level of the simple feature model, and the explanation of the basis is performed by, for example, presenting this degree of contribution. When the basis can also be extracted from the complex feature model, the basis may be extracted directly from the complex feature model without going through the simple feature model. For calculating the degree of contribution of features, by way of example, Shapley values are used. The technique using Shapley values is a method that fairly allocates gains according to the degree of contribution of players in traditional game theory. In the present system, the game in Shapley values is replaced by machine learning, the players in Shapley values are replaced by the features of the present system, and the gains in Shapley values are replaced by the predicted values of the present system, thereby obtaining the degree of contribution of features to the predicted values of the machine learning model. Note that the algorithm for calculating the degree of contribution of features is not limited thereto.

In techniques using Shapley values, the computational cost increases as the number of features increases. Therefore, in the present system, by way of example, the well-known SHAP (SHapley Additive explanations) is used as a technique for approximating Shapley values. In a multi-class classification model that classifies CEFR levels (A1 to C2) using the word sequences of utterance texts by the conversational agent and the user as features, how much each word, which is a feature, contributes to the predicted probability of each CEFR level (SHAP value) is obtained by SHAP. From the SHAP values obtained here, it is possible to know whether each word contributed positively or negatively to the predicted probability of each CEFR level from A1 to C2. In other words, by applying SHAP to the simple feature model, it is possible to visually confirm which feature contributed how much to the CEFR level determination.

The visualization unit 135 visualizes the score obtained by the score measurement unit 133 and the basis for the score. FIG. 21 is a diagram showing an example of a radar chart. The case of using a radar chart as one method of score visualization by the visualization unit 135 will be described with reference to FIG. 21. The visualization unit 135 displays the user's scores obtained by the score measurement unit 133 for each index as a radar chart (the portion indicated by a thick line in FIG. 21) as illustrated in FIG. 21. From this radar chart, it can be seen that the user's overall proficiency is C2. Note that in visualization, other indexes may be added or one or more indexes may be omitted. Also, the visualization method is not limited to a radar chart.

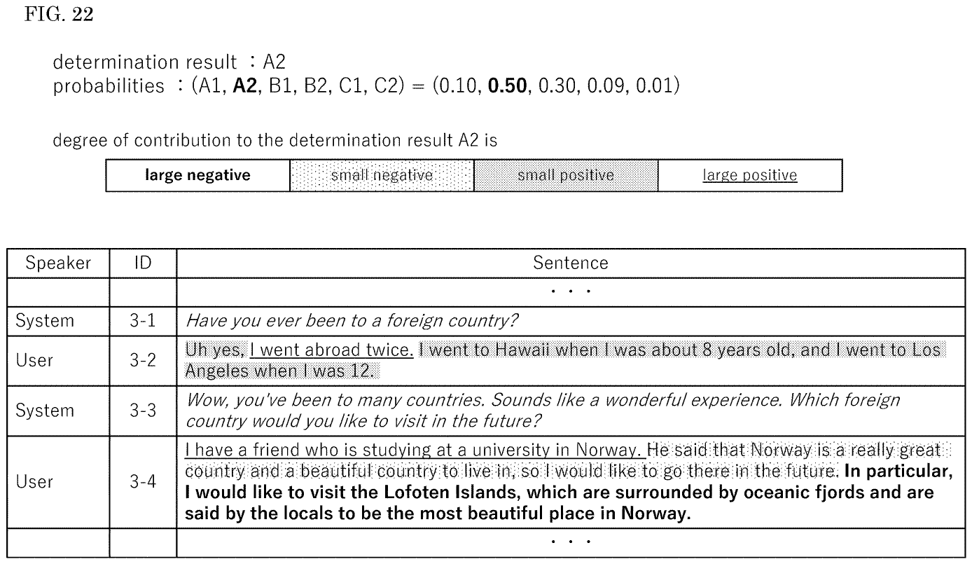

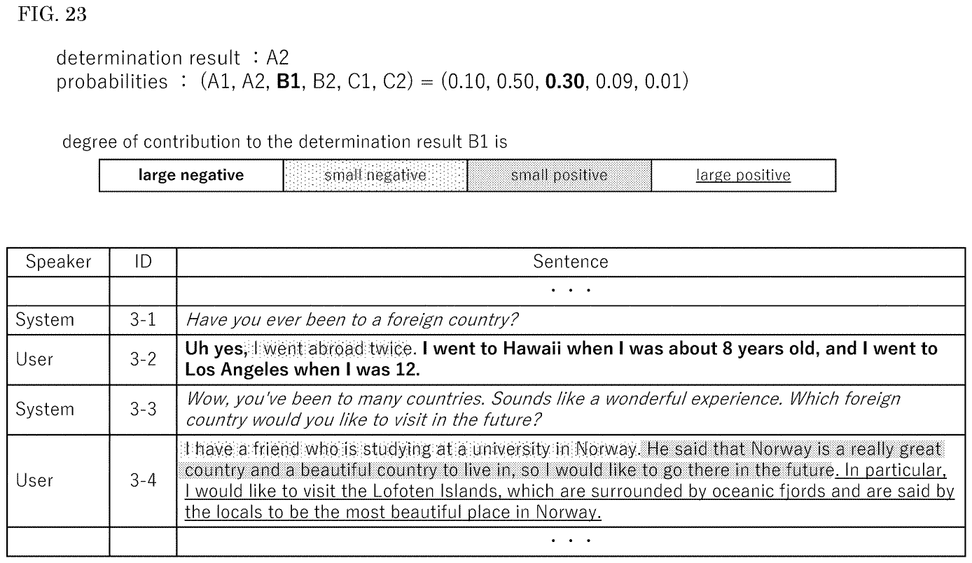

Visualization of the basis for a score by the visualization unit 135 will be described with reference to FIG. 22 and FIG. 23. FIG. 22 is an example in which the degree of contribution (SHAP value) of each word to the probability of A2 of 0.50 is visualized, in the case where the range of vocabulary level among CEFR indexes is A2 and the probabilities (A1, A2, B1, B2, C1, C2) are determined to be (0.10, 0.50, 0.30, 0.09, 0.01). In FIG. 22, the “Speaker” column indicates the speaker; for example, “System” indicates that the speaker is the conversational agent, and “User” indicates that the speaker is the user. In FIG. 22, for the purpose of explanation, sentences uttered by the conversational agent are shown in italics. The “Sentence” column shows the text uttered by the speaker in the same row. The “ID” column shows the identifier of the text described in “Sentence” in the same row, and here consists of topic number-turn number.

In FIG. 22, for SHAP values (continuous values), thresholds are set for positive values and negative values respectively, and a SHAP value that is positive and at or above the threshold is displayed as “large positive,” one that is positive and below the threshold is displayed as “small positive,” similarly a SHAP value that is negative and at or below the threshold is displayed as “large negative,” and one that is negative and above the threshold is displayed as “small negative” for visualization. For the determination result A2, expressions (word sequences) whose degree of contribution is a large negative are displayed in bold, expressions whose degree of contribution is a small negative are displayed with a dotted screen, expressions whose degree of contribution is a small positive are displayed in gray, and expressions whose degree of contribution is a large positive are displayed with an underline. The display format illustrated in FIG. 22 is merely an example and is not limited thereto.

FIG. 23 is an example in which the degree of contribution (SHAP value) of each word to the probability of B1 of 0.30 is visualized, in the case where the range of vocabulary level among CEFR indexes is A2 and the probabilities (A1, A2, B1, B2, C1, C2) are determined to be (0.10, 0.50, 0.30, 0.09, 0.01). Since the display format of FIG. 23 is the same as FIG. 22, its description is omitted. FIG. 22 illustrated the degree of contribution to the determination result A2, while FIG. 23 displays the degree of contribution to the determination result B1. By presenting (comparing) these FIG. 22 and FIG. 23 to the user, from FIG. 22 it is possible to confirm which expression (word sequence) contributed how much to the A2 determination (degree of contribution to determination probability A2).

On the other hand, from FIG. 23, it is possible to confirm which expressions (word sequences) were evaluated as B1 despite the overall determination result being A2, and the degree thereof (degree of contribution to determination probability B1). Taking as an example the last sentence in the utterance with “ID” 3-4 (the sentence beginning with “In particular”), the degree of contribution to determination probability A2 is very low (large negative), while the degree of contribution to determination probability B1 is very large (large positive). From this display, it can be seen that the above expression is one of the reasons it was determined to indicate higher proficiency (B1).

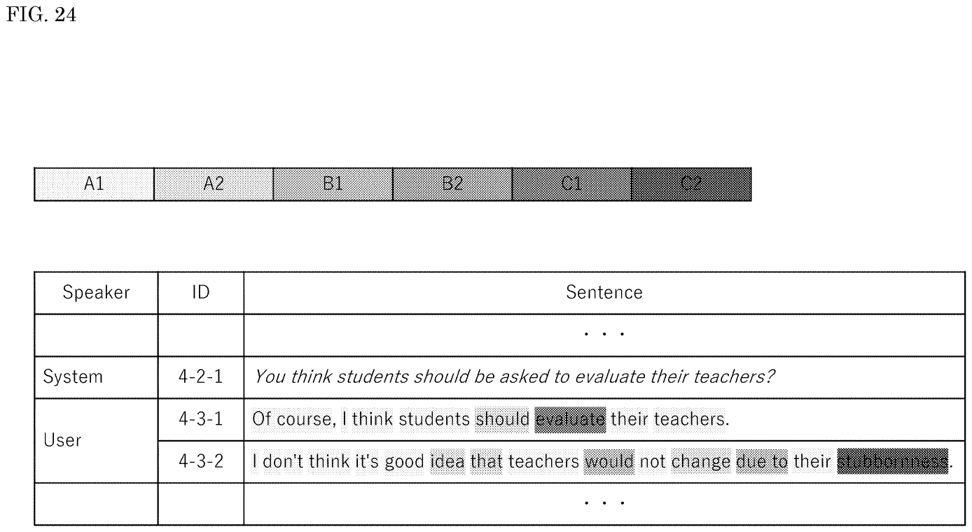

In addition, the above-mentioned linguistic feature extraction unit 131 can also be operated standalone without going through the language proficiency measurement unit 132. In that case, the visualization unit 135 may display the features extracted by the linguistic feature extraction unit 131. FIG. 24 is a diagram showing an example of visualization of CEFR levels of vocabulary contained in a user utterance. In FIG. 24, “ID” consists of topic number-turn number-sentence number. Other display formats in FIG. 24 are the same as FIG. 22 described above, so their description is omitted. In FIG. 24, the results of assigning CEFR levels of A1, A2, B1, B2, C1, and C2 to vocabulary contained in user utterances are visualized. Specifically, in FIG. 24, as the CEFR level of an expression increases (as proficiency increases), that expression is displayed in a darker shade of gray. From this display, it can be confirmed that “stubbornness” in the utterance with “ID” 4-3-2 is a C2-equivalent expression, and it can be seen that this is one of the reasons why range of vocabulary (Range) proficiency was judged to be high.

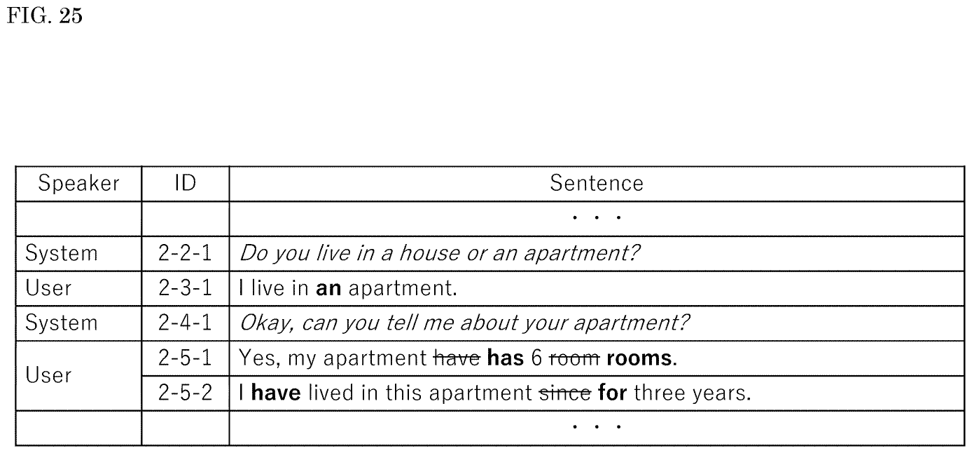

The visualization unit 135 may display the results of grammatical error correction based on grammatical error features extracted by the grammatical error feature extractor of the linguistic feature extraction unit 131. FIG. 25 is a diagram showing an example of visualization of grammatical error features. In FIG. 25, expressions deleted after grammatical error correction are shown with strikethrough, and expressions inserted are shown in bold. Other display formats of FIG. 25 are the same as FIG. 22 and FIG. 24 described above, so their description is omitted. In the sentence with ID 2-3-1, “an” is shown in bold, indicating that “an” was inserted by the grammatical error correction process after the user utterance. This indicates that a correction was made to the user utterance for a preposition error. For example, while the correct answer should include the preposition (an), the user uttered the sentence without a preposition or with an incorrect preposition, so the corrected sentence is displayed from the perspective of the preposition.

In addition, in the sentence with ID 2-5-1, “room” is deleted and “rooms” is shown in bold, indicating that “rooms” was inserted in place of “room” by the grammatical error correction process after the user utterance. This indicates that a correction was made to the user utterance for a grammatical error between singular and plural forms. For example, while the correct answer should be the plural “rooms,” the user uttered the singular “room,” so the corrected sentence in which the singular has been changed to the plural is displayed. This display allows the user to visually confirm his/her own grammatical errors.

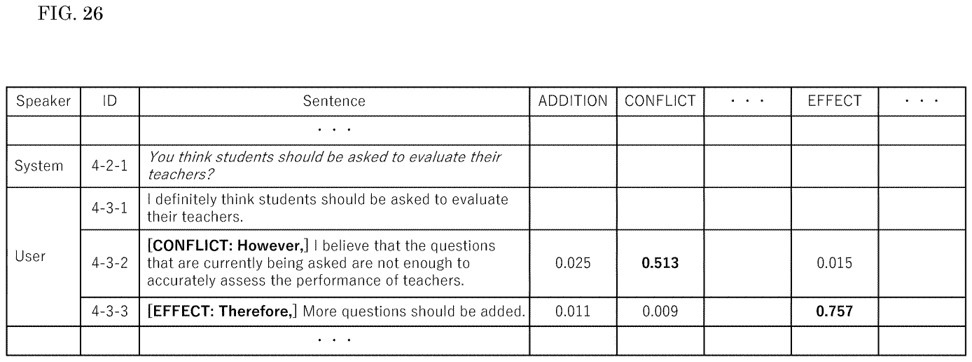

The visualization unit 135 may display discourse features extracted by the discourse feature extractor of the linguistic feature extraction unit 131. FIG. 26 is a diagram showing an example of visualization of discourse features. The display format of FIG. 26 is the same as FIG. 25 described above, so its description is omitted. On the right side of FIG. 26, estimated values (see FIG. 9 and FIG. 10) are displayed for each class of discourse marker. These estimated values are prediction values by the model for each discourse marker class, i.e., the probability that the target sentence and the preceding sentence can be connected by that discourse marker class.

For the sentence with “ID” 4-3-2, referring to the estimated values of discourse marker classes displayed on the right side, the value of “CONFLICT,” the class to which adversative discourse markers such as “However” belong, is the highest. This indicates that sentence 4-3-2 is in an adversative relationship with sentence 4-3-1. Also, for the sentence with “ID” 4-3-3, referring to the estimated values of discourse marker classes displayed on the right side, the value of “EFFECT,” the class to which discourse markers expressing results and conclusions such as “Therefore” belong, is the highest. This indicates that sentence 4-3-3 is a conclusion following sentence 4-3-2.

The result illustrated in FIG. 26 indicates that, as a result of predicting each discourse marker class illustrated in FIG. 10 by the model, the predicted value of the CONFLICT class for the discourse relation holding between sentences 4-3-1 and 4-3-2 exceeded the threshold probability of 0.5. It also indicates that the predicted value of the EFFECT class for the discourse relation holding between sentences 4-3-2 and 4-3-3 exceeded the threshold probability of 0.5. This display allows the user to confirm how well they have structured their speech and how logically they can speak. Note that when the predicted probabilities of a plurality of discourse marker classes exceed the threshold, a plurality of discourse marker classes may be visualized, or just the single discourse marker class with the highest predicted probability among them may be visualized.

The visualization unit 135 may display coreference features extracted by the coreference feature extractor of the linguistic feature extraction unit 131. The above-mentioned FIG. 13 is also a diagram showing an example of visualization of coreference features. Through the display illustrated in FIG. 13, the user can confirm whether they are appropriately managing the topic and speaking coherently while referring to their own past statements and the statements of the conversation partner.

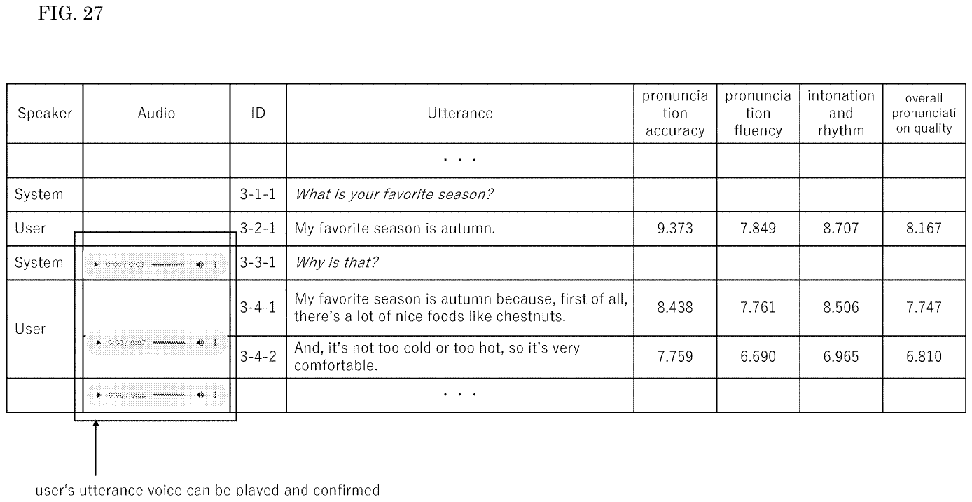

The visualization unit 135 may display pronunciation quality based on pronunciation features extracted by the pronunciation feature extractor of the linguistic feature extraction unit 131. In FIG. 27, “ID” consists of topic number-turn number-utterance segment number. Other display formats in FIG. 27 are the same as FIG. 22 described above, so their description is omitted. On the right side of FIG. 27, values are displayed that are obtained by normalizing, using the score converter (Mathematical Formula 5 through Mathematical Formula 7), the predicted probabilities (probabilities for each of the 11 levels from 0 to 10) from the model (see FIG. 8) to values from 0 to 10 (scalar).

Note that the interpretation of the values displayed on the right side of FIG. 27 is in accordance with the well-known training dataset speechocean762. Although FIG. 27 displays utterances in chronological order, utterances may also be displayed in ranking order from the best pronunciation, and the display format is not limited thereto. This display allows the user to review, in each index such as pronunciation accuracy, pronunciation fluency, intonation and rhythm, and overall pronunciation quality, those aspects of their own utterance pronunciation that were judged to be good and those that were evaluated as not very good. For example, the user can play back and review their own utterance audio using a button shown by the play symbol illustrated in the figure. Note that this display is an example, and data may be arranged based on other indexes.

The translation unit 136 converts the language of the input data when the linguistic feature extraction unit 131 handles multilingual input data. By providing the translation unit 136, even if the linguistic feature extraction unit 131 does not have different feature extractors for each language, feature extraction can be performed using existing feature extractors. Note that this translation unit 136 may be omitted, and for example, an external translation system or translation application outside the present system may be used.

### SUMMARY

Next, the operation and effects of the present embodiment will be described.

According to the information processing method according to the present embodiment, when input data acquired from a user utterance is provided, the user's language proficiency is diagnostically assessed by analyzing the input data through predetermined processing. Specifically, when input data acquired from a user utterance is provided, features are extracted from the input data, and a score measured using an arbitrary index for the user utterance is output from the extracted features. Therefore, language proficiency can be diagnostically assessed based on diverse linguistic features contained in the user's multimodal input data.

According to the information processing method according to the present embodiment, a basis extraction unit 134 and a visualization unit 135 are further provided, and the score obtained by the score measurement unit 133 and the basis for the score obtained by the basis extraction unit 134 are visualized by the visualization unit 135. Therefore, it becomes possible not only to show a score to stakeholders but also to explain the basis for the score.

According to the information processing method according to the present embodiment, the features extracted by the linguistic feature extraction unit 131 may be displayed by the visualization unit 135. This allows the user's linguistic features to be visually fed back, so the user can reflect on their own utterances and conversation with the conversational agent.

According to the information processing method according to the present embodiment, the score converter converts the multidimensional probabilities obtained in the complex feature model and the simple feature model into real number (scalar) scores. This enables a learning user to understand their own growth. For example, for a user who has transitioned from CEFR level A1 to A2, presenting the language proficiency measurement results as A1 (1.11)->A1 (1.37)->A1 (1.66)->A1 (1.92)->A2 (2.1) allows for a more detailed understanding of one's own growth than presenting them as A1->A1->A1->A1->A2.

According to the information processing method according to the present embodiment, the algorithms and techniques used by way of example in the present system have been described, but the form of implementation is not limited thereto. For example, other algorithms may be used in place of these algorithms and techniques.

### SUPPLEMENTARY NOTES

The present embodiment includes the following disclosures.

### (Supplementary Note 1)

All embodiments disclosed herein are illustrative in all respects and should not be considered restrictive. The scope of the present disclosure is indicated not by the above meaning but by the claims, and is intended to include all modifications within the meaning and range equivalent to the claims. Furthermore, the present disclosure is not limited to the embodiments described above, and various modifications are possible within the scope indicated by the claims, and embodiments obtained by appropriately combining technical means disclosed in different embodiments are also included in the technical scope of the present disclosure.

### (Supplementary Note 2)

The information processing method according to Supplementary Note 1, wherein the information processing apparatus comprises at least one feature extractor that extracts the feature in the feature extraction process.

### (Supplementary Note 3)

The information processing method according to Supplementary Note 1, wherein the input data comprises one or more of text information, audio information, and video information, and the feature comprises a vector obtained by converting one or more of the text information, the audio information, and the video information into numerical information.

### (Supplementary Note 4)

The information processing method according to Supplementary Note 1, wherein the feature extraction process includes a process of outputting all or any of text features, multimodal features, vocabulary difficulty features, grammatical error features, pronunciation features, discourse features, coreference features, commonsense features, and manually designed features.

### (Supplementary Note 5)

The information processing method according to Supplementary Note 1, wherein the score measurement process includes a process of measuring the score for at least one or more indexes relating to the language proficiency of the user.

### (Supplementary Note 6)

The information processing method according to Supplementary Note 1, wherein the basis extraction process includes a process of extracting the degree of contribution of each feature explaining the basis for the score.

### (Supplementary Note 7)

The information processing method according to Supplementary Note 1, further comprising a visualization unit that visualizes the basis of the score extracted in the basis extraction process and visually presents the basis to the user.

### (Supplementary Note 8)

An information processing apparatus comprising:
a linguistic feature extraction unit configured to acquire input data including an utterance by a user and extract a feature from the acquired input data; and
a language proficiency measurement unit configured to measure the language proficiency of the user based on an arbitrary index from the extracted feature, wherein the language proficiency measurement unit comprises a score measurement unit that measures a score, and a basis extraction unit that extracts the basis for the score.

### (Supplementary Note 9)

A program for causing a computer to execute an information processing method comprising:
an acquisition process of acquiring input data including an utterance by a user;
a feature extraction process of extracting a feature from the acquired input data; and
a language proficiency measurement process of measuring the language proficiency of the user based on an arbitrary index from the extracted feature,
wherein the language proficiency measurement process includes a score measurement process of calculating a score, and a basis extraction process of extracting the basis for the score.

### (Supplementary Note 10)

A language proficiency diagnostic assessment system comprising:
an information processing apparatus comprising:
a linguistic feature extraction unit configured to acquire input data including an utterance by a user and extract a feature from the acquired input data, and
a language proficiency measurement unit configured to measure the language proficiency of the user based on an arbitrary index from the extracted feature, wherein the language proficiency measurement unit comprises a score measurement unit that measures a score, and a basis extraction unit that extracts the basis for the score; and
a user terminal configured to receive the utterance by the user as input, wherein the language proficiency of the user is measured from the utterance by the user input from the user terminal.

What is claimed is:

1. An information processing apparatus for assessing proficiency of a language, comprising:
a memory that stores a program; and
a processor configured to execute the program to:
acquire multimodal input data of the language, the multimodal input data including a combination of two or more of text information, audio information, and video information;
extract, from the acquired multimodal input data, a plurality of linguistic features including a multimodal feature in which features of different modalities of the multimodal input data are blended with one another;
calculate a score for each of a plurality of indices of the proficiency based on the extracted plurality of linguistic features;
calculate, as a basis for the score, a contribution degree of each of the plurality of linguistic features to the calculated score; and
output the score for each of the plurality of indices together with the basis for the score.

2. The information processing apparatus according to claim 1, wherein
the processor is further configured to execute the program to:
extract a text feature from the text information using a first pre-trained model;
extract an audio-visual feature from a combination of the audio information and the video information using a second pre-trained model; and
cause the text feature and the audio-visual feature to interact across modalities to produce the multimodal feature.

3. The information processing apparatus according to claim 1, wherein
the processor is further configured to execute the program to convert one or more of the text information, the audio information, and the video information into vectors as the plurality of linguistic features.

4. The information processing apparatus according to claim 1, wherein
the plurality of linguistic features further include one or more of a text feature, a vocabulary difficulty feature, a grammatical error feature, a pronunciation feature, a discourse feature, a coreference feature, a commonsense feature, and a manually designed feature.

5. The information processing apparatus according to claim 1, wherein
the plurality of indices include at least two of range of vocabulary, grammatical accuracy, fluency, pronunciation quality, interactional quality, coherence, and overall proficiency.

6. The information processing apparatus according to claim 1, wherein
the contribution degree is calculated for each of a plurality of words contained in an utterance, and indicates how much the corresponding word contributed to the calculated score for at least one of the plurality of indices.

7. The information processing apparatus according to claim 1, wherein
the processor is further configured to execute the program to cause a display to visually present the basis for the score together with the score for each of the plurality of indices.

8. The information processing apparatus according to claim 1, wherein
the processor is further configured to execute the program to input the extracted plurality of linguistic features to a machine learning model that causes interaction among the plurality of linguistic features and outputs, for each of the plurality of indices, a prediction result, and
the score for each of the plurality of indices is calculated based on the prediction result output by the machine learning model.

9. The information processing apparatus according to claim 8, wherein
the machine learning model includes, for each of the plurality of linguistic features, a corresponding encoder that encodes the linguistic feature into a vector sequence, and a common network that causes interaction among the vector sequences output from the corresponding encoders to output the prediction result for each of the plurality of indices.

10. The information processing apparatus according to claim 8, wherein
the machine learning model has been trained using a loss function that penalizes a misclassification between two classes more heavily as a distance between the two classes increases.

11. The information processing apparatus according to claim 1, wherein
the contribution degree of each of the plurality of linguistic features indicates both a direction and a magnitude with which the linguistic feature contributes to the calculated score, the direction being one of a positive contribution that increases the calculated score and a negative contribution that decreases the calculated score.

12. The information processing apparatus according to claim 1, wherein
the processor is further configured to execute the program to divide the acquired multimodal input data into a plurality of utterance clauses, each utterance clause being delimited by a punctuation mark in the text information and by a pause of at least a predetermined length in the audio information, and to extract the multimodal feature for each of the plurality of utterance clauses in utterance order.

13. A method for assessing proficiency of a language, the method comprising:
acquiring multimodal input data of the language, the multimodal input data including a combination of two or more of text information, audio information, and video information;
extracting, from the acquired multimodal input data, a plurality of linguistic features including a multimodal feature in which features of different modalities of the multimodal input data are blended with one another;
calculating a score for each of a plurality of indices of the proficiency based on the extracted plurality of linguistic features;
calculating, as a basis for the score, a contribution degree of each of the plurality of linguistic features to the calculated score; and
outputting the score for each of the plurality of indices together with the basis for the score.

14. The method according to claim 13, further comprising:
extracting a text feature from the text information using a first pre-trained model;
extracting an audio-visual feature from a combination of the audio information and the video information using a second pre-trained model; and
causing the text feature and the audio-visual feature to interact across modalities to produce the multimodal feature.

15. The method according to claim 13, further comprising:
converting one or more of the text information, the audio information, and the video information into vectors as the plurality of linguistic features.

16. The method according to claim 13, wherein
the plurality of linguistic features further include one or more of a text feature, a vocabulary difficulty feature, a grammatical error feature, a pronunciation feature, a discourse feature, a coreference feature, a commonsense feature, and a manually designed feature.

17. The method according to claim 13, wherein
the plurality of indices include at least two of range of vocabulary, grammatical accuracy, fluency, pronunciation quality, interactional quality, coherence, and overall proficiency.

18. The method according to claim 13, wherein
the contribution degree is calculated for each of a plurality of words contained in an utterance, and indicates how much the corresponding word contributed to the calculated score for at least one of the plurality of indices.

19. The method according to claim 13, further comprising:
displaying the basis for the score together with the score for each of the plurality of indices.

20. A non-transitory computer-readable medium storing a program for assessing proficiency of a language, the program, when executed by a processor, causing the processor to:
acquire multimodal input data of the language, the multimodal input data including a combination of two or more of text information, audio information, and video information;
extract, from the acquired multimodal input data, a plurality of linguistic features including a multimodal feature in which features of different modalities of the multimodal input data are blended with one another;
calculate a score for each of a plurality of indices of the proficiency based on the extracted plurality of linguistic features;
calculate, as a basis for the score, a contribution degree of each of the plurality of linguistic features to the calculated score; and
output the score for each of the plurality of indices together with the basis for the score.
